(19) United States
(12) Patent Application Publication
(10) Pub. No.: US 2025/0233899 A1
(43) Pub. Date: Jul. 17, 2025

(54) METHOD AND DEVICE FOR SETTING UP SESSION IN COMMUNICATION SYSTEM

(71) Applicant: Samsung Electronics Co., Ltd., Suwon-si (KR)

(72) Inventors: Jaehyeon BAE, Suwon-si (KR); Dongyeon KIM, Suwon-si (KR)

(21) Appl. No.: 19/016,369

(22) Filed: Jan. 10, 2025

(30) Foreign Application Priority Data
Jan. 11, 2024 (KR) 10-2024-0004990
Oct. 11, 2024 (KR) 10-2024-0138573

(51) Int. Cl. H04L 65/1069; H04L 65/1016

(52) U.S. Cl. CPC H04L 65/1069; H04L 65/1016

(57) ABSTRACT

The disclosure relates to a fifth generation (5G) or sixth generation (6G) communication system for supporting a higher data transmission rate. A method performed by an entity that performs data channel signaling functions in a communication system is provided. The method includes transmitting a first message, which includes information related to an avatar of a first user equipment (UE) and information related to an application data channel connection request, to an entity that performs an avatar storage function, receiving a message, from the entity performing the avatar storage function, which includes information related to a response to the application data channel connection request, requesting a list of avatar representation information from the entity performing the avatar storage function, and receiving the list of avatar representation information from the entity performing the avatar storage function.

### CROSS-REFERENCE TO RELATED APPLICATION(S)

This application is based on and claims priority under 35 U.S.C. § 119 (a) of a Korean patent application number 10-2024-0004990, filed on Jan. 11, 2024, in the Korean Intellectual Property Office, and of a Korean patent application number 10-2024-0138573, filed on Oct. 11, 2024, in the Korean Intellectual Property Office, the disclosure of each of which is incorporated by reference herein in its entirety.

### BACKGROUND

### 1. Field

The disclosure relates to a session setup method and device in a communication system. More particularly, the disclosure relates to a session setup method and device based on network storage.

### 2. Description of Related Art

Fifth generation (5G) mobile communication technologies define broad frequency bands such that high transmission rates and new services are possible, and can be implemented not only in “Sub 6 gigahertz (GHz)” bands, such as 3.5 GHz, but also in “Above 6 GHz” bands referred to as millimeter wave (mmWave) including 28 GHz and 39 GHz. In addition, it has been considered to implement 6G mobile communication technologies (referred to as Beyond 5G systems) in terahertz (THz) bands (for example, 95 GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced mobile broadband (eMBB), ultra reliable low latency communications (URLLC), and massive machine-type communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of bandwidth part (BWP), new channel coding methods, such as a low density parity check (LDPC) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies, such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, new radio (NR) user equipment (UE) power saving, non-terrestrial network (NTN) which is UE-satellite direct communication for providing coverage in an area in which communication with terrestrial networks is unavailable, and positioning.

Moreover, there has been ongoing standardization in air interface architecture/protocol regarding technologies, such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies, such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and artificial intelligence (AI) from the design stage and internalizing end-to-end AI support functions, and next-generation distributed computing technology for implementing services at levels of complexity exceeding the limit of UE operation capability by utilizing ultra-high-performance communication and computing resources.

An Internet protocol (IP) multimedia subsystem (IMS) system is a system for transmitting multimedia based on the Internet protocol (IP), and various services, such as voice over long term evolution (VOLTE), voice over NR (VONR), or the like, are provided through a legacy IMS network associated with a long term evolution (LTE) or 5G network. An IMS data channel service aims to provide various additional services, such as screen sharing and user location information transmission using a separate application in addition to the legacy voice- or video-based services using an IMS-associated data channel, i.e., Internet protocol (IP) multimedia subsystem-data channel (IMS-DC), service in services, such as the legacy RTP-based voice, video, or text services. To use an additional service or standalone IMS data channel service using a data channel in the IMS data network, the user equipment (UE) may transmit, to the network, a signaling message including a data channel application and related configuration information request for a data channel-based service through a bootstrap data channel setup signaling procedure. The IMS data channel network receiving the signaling message may transfer, to the UE, application or application list information based on the request information received from the UE and configurations of the service operator or the user, thereby transmitting information for downloading the application for the data channel service. The UE may select an appropriate data channel application and request a corresponding data channel application according to the user's selection and the performance of the UE based on the application or application list information received from the network. Further, the network may allocate a separate media function entity in the network during the bootstrap data channel setup process to support download of a specific application requested by the UE. The corresponding media function entity may receive data channel application-related information (replacement HTTP URL representing the application list offered via the MDC1 interface) for conversion into data channel application information, through a media resource management service operation during the bootstrap data channel setup process. Thereafter, the media function entity may receive specific data channel application information selected and requested by the UE through an Mb interface and then convert the corresponding data channel application download request information into HTTP URL information that may be recognized by the IMS data channel network (e.g., data channel signaling function (DSCF)) and perform the application download support operation of the UE. Multiplexed data streams may be supported according to the type of the service. The UE may receive each data channel application through a bootstrap connection process while simultaneously receiving data channel application-related information. Thereafter, the UE may perform an application data channel setup signaling operation to request data channel connection of the received data channel application. Application binding information including configuration information for supporting a specific application may be transferred together in the application data channel setup signaling message. The network may perform at least one application data channel connection operation among three types of application data channel connections, such as UE-to-UE (peer-to-peer (P2P) application data channel setup), UE-to-application server (peer-to-application (P2A) application data channel setup), and UE-to-UE over application server ((peer-to-application-to-peer (P2A2P) application data channel setup) connection, based on the above-described information received from the UE.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method for receiving and updating avatar representation information supported by an avatar storage entity over a network during IMS data channel service-based avatar call session connection using avatar storage over network.

Another aspect of the disclosure is to provide a method and device for managing avatar representation information and receiving avatar representation data using an avatar identification (ID) to address, e.g., privacy issues when the UE requests and manages an avatar information request.

Additional aspects will be set forth in part in the description which follows and, in part, will be apparent from the description, or may be learned by practice of the presented embodiments.

In accordance with an aspect of the disclosure, a method performed by an entity that performs data channel signaling functions in a communication system is provided. The method includes transmitting a first message, which includes information related to an avatar of a first user equipment (UE) and information related to an application data channel connection request, to an entity that performs an avatar storage function receiving a message, from the entity performing the avatar storage function, which includes information related to a response to the application data channel connection request, requesting a list of avatar representation information from the entity performing the avatar storage function, and receiving the list of avatar representation information from the entity performing the avatar storage function.

In accordance with another aspect of the disclosure, a method performed by a first UE in a communication system is provided. The method includes transmitting a first message to an IP multimedia subsystem application server (IMS AS), the first message including information related to an avatar and information related to an application data channel connection request, and receiving avatar representation information through a media function (MF) from the IMS AS, wherein the avatar representation information includes a list of avatar representation information.

In accordance with another aspect of the disclosure, an entity that performs data channel signaling functions in a communication system is provided. The entity includes a transceiver, and at least one processor, wherein the at least one processor is configured to transmit a first message, which includes information related to an avatar of a first UE and information related to an application data channel connection request, to an entity that performs an avatar storage function, receive a message, from the entity performing the avatar storage function, which includes information related to a response to the application data channel connection request, request a list of avatar representation information from the entity performing the avatar storage function, and receive the list of avatar representation information from the entity performing the avatar storage function.

In accordance with another aspect of the disclosure, a first UE in a communication system is provided. The UE includes a transceiver, and at least one processor, wherein the at least one processor is configured to transmit a first message to an IP multimedia subsystem application server (IMS AS), the first message including information related to an avatar and information related to an application data channel connection request, and receive avatar representation information through a media function (MF) from the IMS AS, wherein the avatar representation information includes a list of avatar representation information.

In the method and device according to an embodiment of the disclosure, the UE performs reception and management of avatar representation information providable from an avatar storage function entity based on avatar representation-related information (avatar ID, avatar model descriptor, avatar version, avatar service info, calling ID, called ID, or the like) received from the UE in the DCSF based on the requirements of the avatar-based IMS-DC service and perform a bootstrap data channel setup process for transferring the same to the counterpart UE or network.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a view illustrating a network structure and interface of a 5G system according to an embodiment of the disclosure;

FIG. 2 illustrates an Internet protocol (IP) multimedia subsystem data channel (IMS-DC) structure providing a data channel service based on an IP multimedia subsystem (IMS) service according to an embodiment of the disclosure;

FIG. 3 illustrates a reference structure constituting an avatar-based service according to an embodiment of the disclosure;

FIG. 4 illustrates a structure for describing an operation in which a UE requests avatar representation information and receives related information through a bootstrap data channel setup signaling procedure in an avatar service using avatar storage over a network according to an embodiment of the disclosure;

FIG. 5 is a flowchart illustrating a bootstrap data channel setup signaling procedure on a data channel server (DCS) side according to a call session connection request including avatar representation-related information transferred by a UE according to an embodiment of the disclosure;

FIG. 6 is a flowchart illustrating a bootstrap data channel signaling procedure between a UE and a remote network and a local DCS related to an avatar service using avatar storage over a network according to an embodiment of the disclosure;

FIG. 7A is a flowchart illustrating a bootstrap data channel signaling procedure between a local DCS and a UE and a remote network related to an avatar service using avatar storage over a network according to an embodiment of the disclosure;

FIG. 7B is a flowchart illustrating a bootstrap data channel signaling procedure between a local DCS and a UE and a remote network related to an avatar service using avatar storage over a network according to an embodiment of the disclosure;

FIG. 8A is a flowchart illustrating a bootstrap data channel setup signaling procedure for updating service-related information after updating avatar representation information in avatar storage in a UE according to an embodiment of the disclosure;

FIG. 8B is a flowchart illustrating a bootstrap data channel setup signaling procedure for updating service-related information after updating avatar representation information in avatar storage in a UE according to an embodiment of the disclosure;

FIG. 9A is a flowchart illustrating an application data channel setup signaling procedure based on avatar representation information in avatar storage in a UE according to an embodiment of the disclosure;

FIG. 9B is a flowchart illustrating an application data channel setup signaling procedure based on avatar representation information in avatar storage in a UE according to an embodiment of the disclosure;

FIG. 9C is a flowchart illustrating an application data channel setup signaling procedure based on avatar representation information in avatar storage in a UE according to an embodiment of the disclosure;

FIG. 10 is a view schematically illustrating an example of a structure of a network entity according to an embodiment of the disclosure;

FIG. 11 is a view schematically illustrating an example of a structure of a UE according to an embodiment of the disclosure;

FIG. 12 is a block diagram schematically illustrating another example of a structure of a UE according to an embodiment of the disclosure;

FIG. 13 is a block diagram schematically illustrating another example of a structure of a network entity according to an embodiment of the disclosure; and

FIG. 14 is a flowchart illustrating the avatar service process in a terminal according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary.

Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

For the same reasons, some elements may be exaggerated or schematically shown. The size of each element does not necessarily reflect the real size of the element. The same reference numeral is used to refer to the same element throughout the drawings.

Hereinafter, a base station (BS) is an entity that performs resource allocation of a UE, and may be at least one of a gNode B, eNode B, Node B, (or xNode B (where x is an alphabetic character including g and e)), a radio access unit, a base station controller, a satellite, an airborne, or a node on network. The user equipment (UE) may include a mobile station (MS), vehicle, satellite, airborne, cellular phone, smartphone, computer, or multimedia system capable of performing communication functions. In the disclosure, downlink (DL) refers to a wireless transmission path of signal transmitted from the base station to the terminal, and uplink (UL) refers to a wireless transmission path of signal transmitted from the terminal to the base station. Additionally, a sidelink (SL) meaning a radio transmission path of a signal transmitted from a UE to another UE may exist.

Although LTE, long term evolution advanced (LTE-A), or 5G systems may be described below as an example, the embodiments may be applied to other communication systems having a similar technical background or channel pattern. For example, embodiments of the disclosure may also encompass 5G-advance or NR-advance or 6th generation mobile communication technology (6G) developed after 5G mobile communication technology (or new radio, NR). The following 5G may be a concept encompassing the legacy LTE, LTE-A and other similar services. Further, the embodiments may be modified in such a range as not to significantly depart from the scope of the disclosure under the determination by one of ordinary skill in the art and such modifications may be applicable to other communication systems.

It should be appreciated that the blocks in each flowchart and combinations of the flowcharts may be performed by computer program instructions. Since the computer program instructions may be equipped in a processor of a general-use computer, a special-use computer or other programmable data processing devices, the instructions executed through a processor of a computer or other programmable data processing devices generate means for performing the functions described in connection with a block(s) of each flowchart. Since the computer program instructions may be stored in a computer-available or computer-readable memory that may be oriented to a computer or other programmable data processing devices to implement a function in a specified manner, the instructions stored in the computer-available or computer-readable memory may produce a product including an instruction means for performing the functions described in connection with a block(s) in each flowchart. Since the computer program instructions may be equipped in a computer or other programmable data processing devices, instructions that generate a process executed by a computer as a series of operational steps are performed over the computer or other programmable data processing devices and operate the computer or other programmable data processing devices may provide steps for executing the functions described in connection with a block(s) in each flowchart.

Further, each block may represent a module, segment, or part of a code including one or more executable instructions for executing a specified logical function(s). Further, it should also be noted that in some replacement embodiments, the functions mentioned in the blocks may occur in different orders. For example, two blocks that are consecutively shown may be performed substantially simultaneously or in a reverse order depending on corresponding functions.

As used herein, the term “unit” means a software element or a hardware element, such as a field-programmable gate array (FPGA) or an application specific integrated circuit (ASIC). A unit plays a certain role. However, ‘unit’ is not limited to software or hardware. A ‘unit’ may be configured in a storage medium that may be addressed or may be configured to execute one or more processors. Accordingly, as an example, a ‘unit’ includes elements, such as software elements, object-oriented software elements, class elements, and task elements, processes, functions, attributes, procedures, subroutines, segments of program codes, drivers, firmware, microcodes, circuits, data, databases, data architectures, tables, arrays, and variables. Functions provided within the components and the ‘units’ may be combined into smaller numbers of components and ‘units’ or further separated into additional components and ‘units’. Further, the components and ‘units’ may be implemented to execute one or more CPUs in a device or secure multimedia card. According to embodiments of the disclosure, a “ . . . unit” may include one or more processors.

The disclosure relates to an avatar call session connection service using avatar storage and, more specifically, to a method and device for supporting reception and update of an avatar representation or base avatar information in avatar storage over a network during a boot strap data channel setup signaling procedure and/or application data channel setup signaling procedure for Internet protocol (IP) multimedia subsystem-data channel (IMS-DC)-based avatar service connection.

The third generation partnership project (3GPP), which is in charge of cellular mobile communication standardization, has named the new core network structure 5G core (5GC) and standardized the same to promote the evolution from the fourth generation (4G) LTE system to the 5G system. 5GC supports the following differentiated functions as compared to the evolved packet core (EPC), which is the network core for 4G.

5GC adopts the network slicing function. As a requirement of 5G, 5GC should support various types of terminals and services, e.g., enhanced mobile broadband (eMBB), ultra reliable low latency communications (URLLC), or massive machine type communications (mMTC). These UEs/services have different requirements for the core network. For example, the eMBB service may require a high data rate while the URLLC service may require high stability and low latency. There has been proposed network slicing technology to meet such various requirements.

Network slicing may mean a method for creating several logical networks (e.g., network slices) by virtualizing one physical network. An activated network slice may be referred to as a network slice instance, and each network slice instance (NSI) may have a different characteristic. The mobile communication operator may meet various service requirements according to the UE/service by configuring a network function (NF) fitting the characteristics of each NSI. For example, the mobile communication operator may allocate the NSI fitting the characteristics of the service required for each UE and efficiently support several 5G services (e.g., eMBB, URLLC, or mMTC).

5GC may seamlessly support the network virtualization paradigm through separation of the mobility management function and the session management function. In 4G LTE, all UEs may receive services over the network through signaling exchange with a single core entity called the mobility management entity (MME) in charge of registration, authentication, mobility management and session management functions. In 5G, the number of UEs (including, e.g., MTC UEs) explosively increases and mobility and traffic/session characteristics that need to be supported according to the type of UE are subdivided. Resultantly, if all functions are supported by a single device, such as MME, the scalability of adding entities for each required function may decrease. Accordingly, various functions are under development based on a structure that separates the mobility management function and the session management function to enhance the scalability in terms of function/implementation complexity of the core entity in charge of the control plane and the signaling load.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

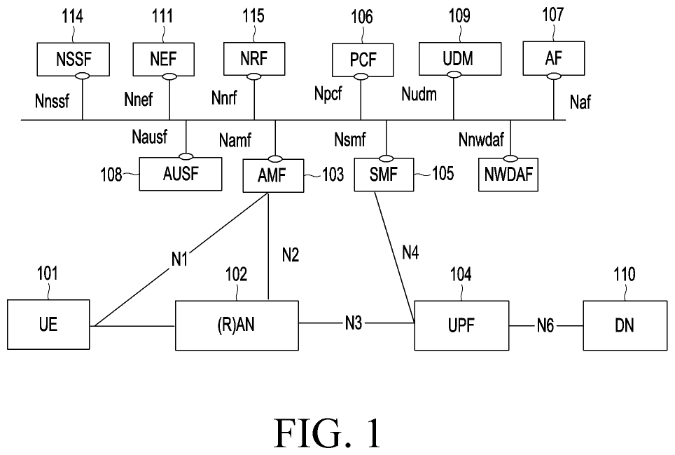

FIG. 1 is a view illustrating a network structure and interface of a 5G system according to an embodiment of the disclosure.

The network entity included in the network architecture of the 5G system of FIG. 1 may include a network function (NF) according to system implementation.

Referring to FIG. 1, the network structure of the 5G system may include various network entities. As an example, the 5G system may include an authentication server function (AUSF) entity 108, an (core) access and mobility management function (AMF) entity 103, a session management function (SMF) entity 105, a policy control function (PCF) entity 106, an application function (AF) entity 107, a unified data management (UDM) entity 109, a data network (DN) entity 110, a network exposure function (NEF) entity 111, a network slicing selection function (NSSF) entity 114, a network repository function (NRF) entity 115, an edge application service domain repository (EDR) (not shown), an edge application server (EAS), an EAS discovery function (EASDF), a user plane function (UPF) entity 104, a (radio) access network ((R)AN) 102, and a terminal, e.g., user equipment (UE) 101.

Each NF entity of the 5G system 100 supports the following functions.

The AUSF 108 processes and stores data for authenticating the UE 101.

The AMF 103 provides functions for per-UE access and mobility management and may connect basically to one AMF per UE. Specifically, the AMF 103 supports such functions as inter-CN node signaling for mobility between 3GPP access networks, radio access network (RAN) CP interface (i.e., N2 interface) termination, NAS signaling termination (N1), NAS signaling security (NAS ciphering) and integrity protection, AS security control, registration management (registration area management), connectivity management, idle mode UE reachability (including controlling and performing paging retransmission), mobility management control (subscription and policy), intra-system mobility and inter-system mobility support, support of network slicing, SMF selection, lawful intercept (for interface to AMF event and LI system), transfer of session management (SM) messages between UE and SMF, transparent proxy for SM message routing, access authentication, access authorization including a roaming authority check, transfer of SMS messages between UE and SMSF, security anchor function (SEA), and security context management (SCM). All or some of the functions of the AMF entity 103 may be supported in a single instance of one AMF entity.

The DN 110 means, e.g., an operator service, Internet access, or a third party service. The DN 110 transmits a downlink protocol data unit (PDU) to the UPF entity 104 or receives a PDU transmitted from UE 101 from UPF entity 104.

The PCF entity 106 receives information about packet flow from application server and provides the function of determining the policy, such as mobility management or session management. Specifically, the PCF entity 106 supports functions, such as support of a signalized policy framework for controlling network operations, providing a policy rule to allow control plane function entity(ies) (e.g., AMF entity or SMF entity) to execute a policy rule, and implementation of a front end for accessing subscription information related to policy decision in the user data repository (UDR).

The SMF entity provides session management function and, if the UE 101 has multiple sessions, this may be managed per session by a different SMF entity. Specifically, the SMF entity 105 supports such functions as session management (e.g., session establishment, modification, and release including maintaining tunnel between the UPF 104 entity and the (R)AN 102 node), UE IP address allocation and management (optionally including authentication), selection and control of a UP function, traffic steering settings for routing traffic to a proper destination in UPF entity 104, interface termination towards policy control functions, execution of control part of policy and QoS, lawful intercept (for interface to SM event and LI system), termination of session management (SM) part of NAS message, downlink data notification, access network (AN)-specific SM information publisher (transferred via the AMF entity 103 and N2 to the (R)AN 102), session and service continuity (SSC) mode decision of session, and roaming function. All or some of the functions of the SMF entity 105 may be supported in a single instance of one SMF entity.

The UDM entity 109 stores, e.g., user's subscription data, policy data. The UDM entity 109 includes two parts, i.e., application front end (FE) and user data repository (UDR).

Front end (FE) includes UDM FE in charge of location management, subscription management, and credential processing, and PCF entity in charge of policy control. The UDR stores data required for the functions provided by UDM-FE and the policy profile required by the PCF entity. Data stored in UDR includes policy data and user subscription data including session-related subscription data and access and mobility-related subscription data, security credential, and subscription identity. The UDM-FE accesses the subscription information stored in UDR and supports such functions as authentication credential processing, user identification handling, access authentication, registration/mobility management, subscription management, and SMS management.

The UPF entity 104 transfers the downlink PDU, received from the DN 110, to the UE 101 via the (R)AN 102 and transfers the PDU, received from the UE 101 via the (R)AN 102, to the DN 110. Specifically, the UPF entity 104 supports such functions as anchor point for intra/inter RAT mobility, external PDU session point of interconnection to data network, packet routing and forwarding, packet inspection and user plane part of policy rule, lawful intercept, traffic usage reporting, uplink classifier for supporting routing of traffic flow to data network, branching point for supporting multi-home PDU session, QoS handling (e.g., packet filtering, gating, uplink/downlink rate execution) for user plane, uplink traffic verification (SDF mapping between service data flow (SDF) and QoS flow), transport level packet marking in uplink and downlink, downlink packet buffering, and downlink data notification triggering. All or some of the functions of the UPF entity 104 may be supported in a single instance of one UPF.

The AF entity 107 interacts with 3GPP core network for providing services (e.g., supporting such functions as application influence on traffic routing, network capability exposure approach, and interactions with policy framework for policy control).

The (R)AN 102 collectively refers to new radio access technologies that support both evolved E-UTRA (E-UTRA) which is an evolution from 4G radio access technology and new radio access technology (new radio (NR)) (e.g., gNB).

gNB supports such functions as functions for radio resource management (i.e., radio bearer control, radio admission control, connection mobility control, dynamic allocation of resources (i.e., scheduling) to UE on uplink/downlink), Internet protocol (IP) header compression, encryption and integrity protection of user data stream, where routing to AMF is not determined from information provided to UE, selection of an AMF when UE attaches, routing of user plane data to UPF(s), routing of control plane information to AMF, connection setup and release, scheduling and transmission (generated from AMF) of paging message, scheduling and transmission (generated from AMF or operating and maintenance (O&M)) of system broadcast information, measurement and measurement reporting configuration for mobility and scheduling, transport level packet marking on uplink, session management, support of network slicing, QoS flow management and mapping to data radio bearer, support of UE in inactive mode, distribution of NAS messages, NAS node selection, radio access network sharing, dual connectivity, and tight interworking between NR and E-UTRA.

UE 101 means a user device. The user device may be referred to as a terminal, mobile equipment (ME), or mobile station (MS). Further, the user device may be a portable device, such as a laptop computer, mobile phone, personal digital assistant (PDA), smartphone, or multimedia device or may be a non-portable device, e.g., a personal computer (PC) or vehicle-mounted device.

The NEF 111 provides a means to safely expose capabilities and services for, e.g., third party, internal exposure/re-exposure, application functions, and edge computing, provided by the 3GPP network functions. The NEF 111 receives information (based on exposed capability (ies) of other NF(s)) from other NF(s). The NEF 111 may store the received information as structured data using a standardized interface to the data storage network function. The stored information may be re-exposed to other NF entity(ies) and AF entity(ies) by the NEF entity 111 and be used for other purposes, e.g., analysis.

The EASDF is an NF that may add an extension mechanism for DNS (EDNS) client subnet (ECS) option that may be expressed as an IP subnet address which should be added when forwarding the DNS request of the UE 101 and the address of the DNS server to forward the DNS request of the UE 101, per fully qualified domain name (FQDN). The EASDF receives exchange active sync (EAS) domain configuration information from the EDR 113 and processes the DNS request message received from the UE according to the received information. Further, the EASDF is an NF that receives the UE IP address and position information within 3GPP of the UE, DNS message handling rules, and DNS message reporting rules from the SMF 105, processes the DNS query message received from the UE and the DNS response message received from the DNS server, and transmits, to the SMF 105, information in the DNS message and statistic information obtained by processing it, according to the DNS message reporting rule.

The NRF 115 supports service discovery function. receives an NF discovery request from an NF instance and provides discovered NF instance information to the NF instance. further maintains available NF instances and their supporting services.

Meanwhile, although FIG. 1 illustrates an example reference model in which the UE 101 accesses one DN 110 using one PDU session for ease of description, the disclosure is not limited thereto.

The UE 101 may simultaneously access two data networks (i.e., local and central) using multiple PDU sessions. In this case, two SMFs may be selected for different PDU sessions. However, each SMF may have the capability of controlling both the local and central UPFs in the PDU session.

Further, the UE 101 may simultaneously access two (i.e., local and central) data networks provided in a single PDU session.

In the 3GPP system, a conceptual link connecting NFs in the 5G system is defined as a reference point. As an example, reference point(s) included in the 5G system 100 of FIG. 1 are as follows.
N1: the reference point between the UE 101 and the AMF 103
N2: the reference point between N2, (R)AN 102, and AMF 103
N3: the reference point between N2, (R)AN 102, and UPF 104
N4: the reference point between the SMF 105 and the UPF 104
N5: the reference point between the PCF 106 and the AF 107
N6: the reference point between the UPF 104 and the DN 110
N7: the reference point between the SMF 105 and the PCF 106
N8: the reference point between the UDM 109 and the AMF 103
N10: the reference point between the UDM 109 and the SMF 105
N11: the reference point between the AMF 103 and the SMF 105
N12: the reference point between the AMF 103 and the AUSF 108
N13: the reference point between the UDM 109 and the AUSF 108
N14: the reference point between two AMFs 103
N15: the reference point between PCF and AMF in non-roaming scenario and reference point between PCF in visited network and AMF in roaming scenario
Nx: the reference point between the SMF 105 and the EASDF
Ny: the reference point between the NEF (EDF) 111 and the EASDF

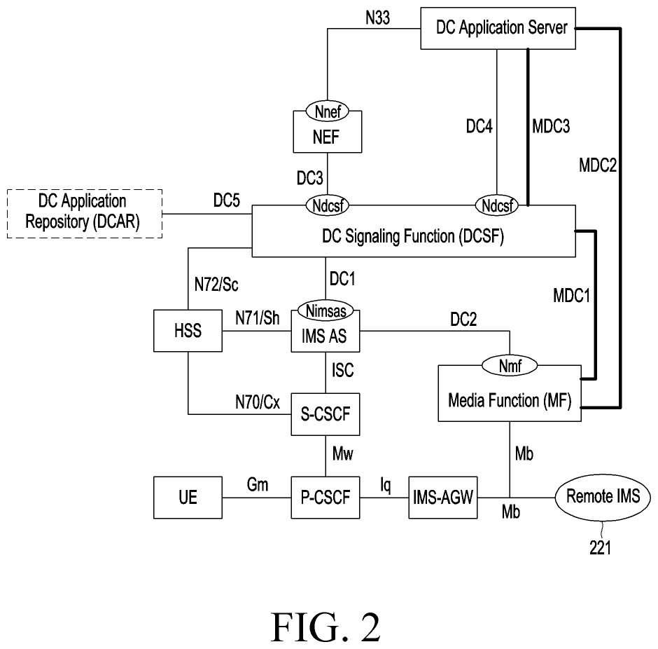

FIG. 2 illustrates an example of an Internet protocol (IP) multimedia subsystem data channel (IMS-DC) structure providing a data channel service based on an Internet protocol (IP) multimedia subsystem (IMS) service according to an embodiment of the disclosure.

In the above structure, the UE may transmit a session initiation protocol (SIP) INVITE message to the existing CSCF for a call session connection request, such as proxy-call session control function (P-CSCF) and serving-call session control function (S-SCSF). In the SIP INVITE message, media-related parameters and multiplexing-related requirement information may be included in a session description protocol (SDP) and together transferred to the network. Further, the UE may transfer an SDP offer including bootstrap information in the SIP INVITE message along with an SDP offer for connecting an existing video or audio session to use IMS data channel services.

The S-CSCF that has received the SIP INVITE including the SDP information may, if the SIP INVITE includes the bootstrap data channel SDP offer for data channel service connection request, transfer the corresponding bootstrap-related SDP offer content to the IMS AS. In this case, the S-CSCF may check whether the UE or network supports IMS-DC based on the received bootstrap-related SDP offer and, if both the opposite sides support data channels, determine to transfer information for bootstrap data channel connection for data channel connection to the IMS AS. The IMS AS receiving the bootstrap-related SDP offer message from the S-CSCF may first identify whether the corresponding UE or the subscriber may use the corresponding data channel service from the home subscriber server (HSS). If the user may not use the data channel based on the user profile of the user, a multimedia telephony (MMTel) session setup operation may be performed without the connection of the data channel through a general IMS process. Further, if the user fails to use the data channel-based service, the IMS AS may update the SIP INVITE message by deleting data channel (DC)-related media information in the SIP INVITE message received from S-CSCF and transfer the updated SIP INVITE message to S-CSCF.

If the service user may use an IMS data channel-based service, data channel bootstrapping may be performed through a data channel call request through a data channel signaling function (DCSF). The IMS AS may select the DCSF by performing discovery and selection of a DCSF instance from NRF based on local settings of the network operator or information transferred from the UE. Through the above process, the IMS AS may transfer a session event control notification (SessionEventControl_Notify) message including as information, such SessionEstablishmentRequestEvent, Session ID, CallingID, CalledID, SessionCase, Event initiator, MediaInfoList, or DC Stream ID to the DCSF selected through the above-described process.

The DCSF receiving the DC control request from the IMS AS may perform a policy determination on how to generate the bootstrap data channel based on the related parameters in the DC control request message. Further, the DCSF may determine MDC1 media information so that the UE may download applications through the MF or the MRF.

Based on the determination information, the DCSF may transfer a MediaControl_MediaInstruction message including information, such as SessionID and MediaInstructionSet to the IMS AS. The DCSF may include the MDC1 media endpoint address, DC stream ID, and replacement information of the URL of the application list transferred through the MDC1 interface in the MediaInstructionSet and transfer the same to the IMS AS. Based on this, the DCSF may provide IMS AS with a policy on how to generate a bootstrap data channel using the MF on the originating and terminating sides.

The IMS AS may select an MF through the process of searching and selecting an MF instance or enhanced MRF that supports local settings or DC media functions using the NRF.

The IMS AS may transfer a list of Media Termination Descriptors to the MF selected in the above process through the Nmf_MRM_Create message. The IMS AS may request the creation of two different media terminations. One piece of media termination information may be local bootstrap media-related information, and the other may indicate remote bootstrap media-related information for providing to the remote UE. Each of the media terminations may include resource allocation request information about Mb and MDC1 interfaces. The MF may transfer the negotiation result of the corresponding data channel media resource information to the IMS AS.

The IMS AS may transfer a response to the MediaInstruction request from the DCSF. The corresponding response message may include result information about the operation and MDC1 data channel media resource information negotiation information.

The DCSF may store media resource information in response messages to the MediaInstruction request received from the IMS AS and transfer, to the IMS AS, a response message related to the data channel connection notification (SessionEventControl_Notify) request from the IMS AS.

The IMS AS may transmit an SIP INVITE message including an updated SDP offer to which media information about MF or enhanced MRF is added to the S-CSCF. The S-CSCF may transfer the received SIP INVITE message including the updated SDP offer to the remote network and UE #2.

UE #2 and the terminating network may include the bootstrap data channel-related SDP response in the 18× response message and transfer it to the originating network. The MF or the enhanced MRF may update the data channel media resource information about UE #2 according to the received SDP response message. Thereafter, UE #2 and the terminating network may transmit a 200 OK response message indicating that the request is successfully completed.

The IMS AS may transfer a SessionEventControl Notify message including SessionEstablishmentSuccessEvent, SessionID, and MediaInfoList to the DCSF to indicate successful session connection-related event information. Thereafter, the IMS AS receiving a response message to the successful session connection event notification from the DCSF may transfer, to UE #1, a 200 OK message indicating that the bootstrap data channel is connected. This allows a bootstrap data channel connection between UE #1 and UE #2 and the originating MF or enhanced MRF. Thereafter, UE #1 and UE #2 may request a data channel application by transferring an application request message to the MF or enhanced MRF. If the multi-DC application is supported, it may request an application list. The MF or MRF may change the root URL to application-related URL information based on the replacement URL information received from the DCSF. Thereafter, the MF may transfer the corresponding application request message received from the UE to the DCSF. The DCSF may provide UE #1 and UE #2 with an application list or appropriate data applications according to the UE's data channel processing capability and selection. When the terminating MF or MRF is used according to the location of the MF, the above process may be performed through the terminating DCSF and an appropriate data channel application may be downloaded.

After the IMS session and bootstrap data channel is connected and the data channel application is downloaded to UE #1 and UE #2, UE #1 may transmit a SIP reINVITE message including the updated SDP to the IMS AS. The updated SDP may include not only bootstrap data channel information, but also application data channel request and related DC application binding information.

The IMS AS may determine whether to notify the DCSF of the media change request event based on the user subscription data information. If the IMS AS determines whether to notify the DCSF of the event, a SessionEventControl_Notify message including the MediaChangeRequest Event, SessionID, Event Direction, Event Initiator, and Media Info List may be transferred to the DCSF.

After receiving the session event notification message, the DCSF may determine a policy on how to perform the application data channel connection request according to the related parameters received through the notification message and the network operator's policy. The DCSF may determine to add the application data channel media descriptor into the SDP offer when UE #2 is a target endpoint and an anchor of the local MF or enhanced MRF is not required. If the MF or enhanced MRF is needed as an anchor for the application data channel, the DCSF may instruct the IMS AS to allocate data channel media resources of MF or enhanced MRF by transferring an Nimsas_MediaControl message to the IMS AS.

The DCSF may transfer a response to the session event notification message to the IMS AS. The IMS AS may then transfer the SIP reINVITE message to the originating S-CSCF, and the S-CSCF may transfer it to the terminating network and UE #2.

UE #2 and the terminating network may include a 200 OK response in the SDP response related to the application data channel and transfer it to the originating network. Thereafter, the IMS AS that receives the SDP offer response message including 200 OK from the terminating network may notify the DCSF of a successful data channel change. The DCSF may transmit a response to the notification to the IMS AS and the IMS AS may then transfer the 200 OK response to UE #1 via the originating S-CSCF and P-CSCF. In this case, the P-CSCF of the originating network may perform a QoS procedure of the application data channel media based on the SDP response information including the 200OK response. UE #1 may transmit an ACK to the terminating network. Through the above process, an application data channel connection operation between UE #1 and UE #2 may be performed.

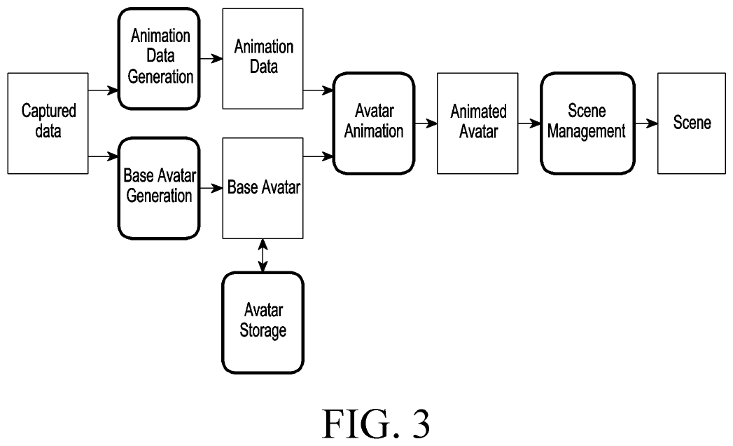

FIG. 3 illustrates an example of a reference structure constituting an avatar-based service according to an embodiment of the disclosure.

Referring to FIG. 3, positions at which each functional entity in the reference structure operates may vary according to the performance and scenario of the UE requesting the avatar service and the network transferring the same.

For example, when the UE supports avatar generation, a base avatar generation function entity and an avatar animation data generation function entity may be positioned at the UE based on the data captured by the camera. Further, if the UE may directly receive or know information about the space where the avatar provided by the counterpart UE or application server is to be positioned, it may also position a functional entity that manages it at the UE.

If the UE only supports base avatar generation and the avatar animation data generation function is provided by the network, the base avatar generation function entity supporting generation of the pre-generated base avatar data or the captured data may be positioned at the UE. Thereafter, according to the camera scheme (e.g., video or depth) supported by the UE, video- or feature point-based data may be transferred to the avatar animation data generation function entity in the network, so that avatar animation data representing the movement of the avatar may be generated based on the data transferred from the UE. As such, each function entity may be set through selection of an appropriate data channel application by the UE during the bootstrap data channel setup signaling procedure according to the performance of the UE or the network or may be set by transferring, to the network, appropriate function entity and related information by the UE during an application data channel setup signaling procedure after selecting a basic data channel application.

In an embodiment of the disclosure, according to the settings of the service operator, the UE may directly store base avatar information to directly transmit data to the network or the counterpart UE when establishing an avatar-related call session or transmit avatar representation information to the network or the counterpart UE through avatar storage in the network.

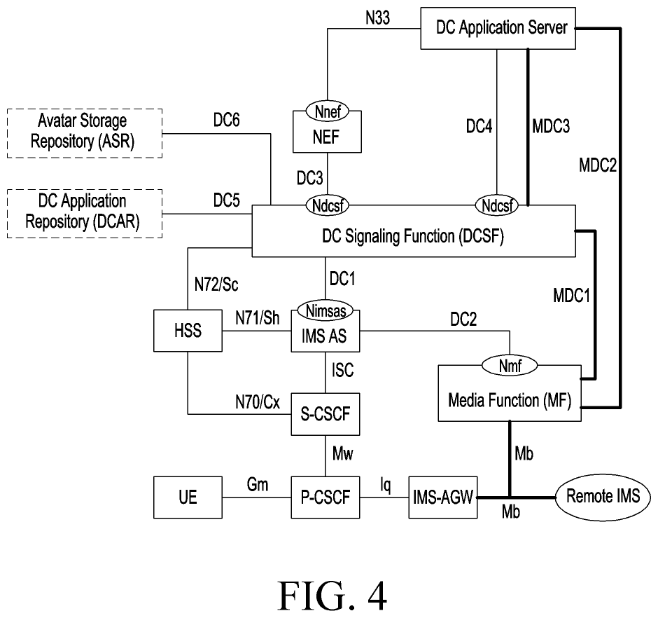

FIG. 4 illustrates an example of a structure for describing an operation in which a UE requests avatar representation information and receives related information through a bootstrap data channel setup signaling procedure in an avatar service using avatar storage over a network according to an embodiment of the disclosure.

Referring to FIG. 4, the UE may receive, from the DCSF, avatar representation information and data channel application information together through a bootstrap data channel setup signaling procedure. To that end, the UE may, by default, include Media info including bootstrap DC stream ID, Calling ID, Called ID, and data channel application-related information in the SIP INVITE message transferred upon bootstrap data channel connection request. Additionally, when the corresponding service is an avatar-based service, avatar representation-related information may be additionally included in the SIP INVITE message. In an embodiment of the disclosure, the avatar representation-related information may include, e.g., Avatar ID, Avatar Model descriptor, and Version.

In an embodiment of the disclosure, the IMS AS may separately select a connection to the DCSF supporting the avatar storage function entity when the avatar representation-related information is included in the data channel service-related request information transferred from the UE. Whether the DSCF supports the avatar storage function entity may be determined based on a service requesting subscription or registered by transferring, to the IMS AS, together DCSF-supportable service-related information upon data channel-related information subscription operation. Further, the DCSF may register service information registerable by the DCSF upon registration to the NRF, and the IMS AS may perform a connection operation for use of a data channel service and selection of a DCSF supporting a necessary service based on information in the SIP INVITE message transferred by the UE.

In an embodiment of the disclosure, the DCSF may perform an operation of requesting and receiving avatar representation information or an avatar representation information list in the avatar storage function entity or the avatar storage repository based on the avatar representation-related information transferred from the UE.

In an embodiment of the disclosure, the DCSF may perform an operation of generating a media resource instruction to be transferred to the MF. In this case, to support an operation for downloading a data channel application of the UE, the DCSF may generate replacement HTTP URL mapping information and a data channel application for actual data channel application transfer request, transferred in the MF from the UE through the Mb interface, and include the same in the media resource instruction and transfer to the MF. Additionally, the replacement HTTP URL mapped to the avatar representation-related information for requesting by the UE may be transferred to the MF to support download of the avatar representation data requested by the UE to support an avatar service using avatar storage in the network.

In an embodiment of the disclosure, the DCSF may update the SDP offer information based on the originating UE-related avatar representation information (originating UE's avatar representation information or list of originating UE's avatar representation information) supported by the avatar storage function entity or the avatar storage repository.

In an embodiment of the disclosure, the terminating UE may select avatar representation information of an appropriate originating UE considering, e.g., the terminating UE's UE performance and supportable codec information based on the originating UE-related avatar representation information (originating UE's avatar representation information or list of originating UE's avatar representation information). Further, the terminating UE may together transfer the terminating UE's avatar representation-related information through response information (SDP answer) to the SDP offer transferred from the originating UE to transfer the terminating UE's avatar representation information provided through the avatar storage function entity or avatar storage repository to the originating UE and the network.

In an embodiment of the disclosure, the originating network (S-SCSF) receiving the SDP answer information including the terminating UE's avatar representation-related information may transfer the terminating UE's avatar representation-related information to the DCSF through the IMS AS. The DCSF may request to transfer the terminating UE's avatar representation information providable from the avatar storage function entity or the avatar storage repository based on the received avatar representation-related information of the terminating UE. The avatar storage function entity or the avatar storage repository may determine the terminating UE's avatar representation information providable based on the terminating UE's avatar representation-related information and service information and transfer the same to the DCSF.

In an embodiment of the disclosure, the DCSF receiving the terminating UE's avatar representation information in the avatar storage function entity or the avatar storage repository may determine to generate replacement URL information mapped to the terminating UE's avatar representation information in the MF. Thereafter, the DCSF may generate media instruction information including replacement URL information mapped to the terminating UE's avatar representation information and transfer it to the MF through a media resource management update operation.

In an embodiment of the disclosure, response information including the avatar representation information of the originating UE and the terminating UE may be transferred to the originating UE through the IMS AS. In this case, the originating UE may determine whether to update originating UE-related avatar representation information in the avatar storage function entity or the avatar storage repository based on the received avatar representation information of the originating UE. Whether to determine to update, or operate, the avatar representation information may be performed by the terminating UE receiving the terminating UE's avatar representation information provided from the avatar storage function entity or the avatar storage repository through an ACK message, as well as by the originating UE.

In an embodiment of the disclosure, if the originating UE or the terminating UE has determined to update the user's avatar representation information in the avatar storage function entity or the avatar storage repository, the operation of updating avatar representation information may be performed and the corresponding result information may be received through a separate channel (e.g., HTTP POST).

In an embodiment of the disclosure, the originating UE or terminating UE completes update of the user's avatar representation information in the avatar storage function entity or the avatar storage repository and then transfer, to the network and the counterpart UE, an SIP re-INVITE message for updating the avatar representation information of the originating UE or the terminating UE which is available in the corresponding service.

In an embodiment of the disclosure, not only avatar representation-related information but also the user's preferred avatar representation information may be transferred in the SIP re-INVITE information transmitted by the UE. For example, when a service is used or is desired to be provided to the counterpart UE based on the latest avatar after completing update of the user's avatar representation information in the avatar storage function entity or the avatar storage repository, related information may be included to use the avatar representation information of the latest version in the preferred avatar representation information and be transferred to the counterpart network and the UE.

In an embodiment of the disclosure, when each UE performs rendering of avatar representation information, the avatar representation information may be downloaded during a bootstrap data channel setup signaling operation. In this case, the UE may receive, from the DCSF, avatar representation information by transferring the avatar ID to the MF to download the avatar representation information of the counterpart UE user available in the avatar service. The MF receiving the avatar ID from the UE may convert it into the replacement HTTP URL mapped to the avatar ID and transfer an avatar representation information request from the DCSF through MDC1. The DCSF receiving the request information may receive the avatar representation information requested by the user from the avatar storage connected to the DCSF and transfer the same to the UE through the MF.

In an embodiment of the disclosure, when rendering of the avatar representation information is performed by the network, the avatar ID may be transferred as application binding media information in the application data channel setup signaling. The DCSF receiving the application binding information including the avatar ID from the UE may include the avatar ID information in the media instruction in the MF. Thereafter, the DCSF may transfer the media instruction information including the avatar ID information to the MF to allocate media functions in the MF to perform an avatar-related operation. The MF to which the avatar ID and temporary avatar storage function has been allocated may, when the response message transferred from the terminating UE accepts the avatar-related setup operation (network-based rendering) in the MF as 200 OK, convert the avatar ID into the replacement HTTP URL stored in the MF and request and receive avatar representation information from the DCSF. In this case, avatar representation information to be used in the avatar storage in the MF may be transferred in the form of the replacement HTTP URL information mapped to the avatar ID instead of the avatar ID according to the settings of the DCSF or the settings of the network operator.

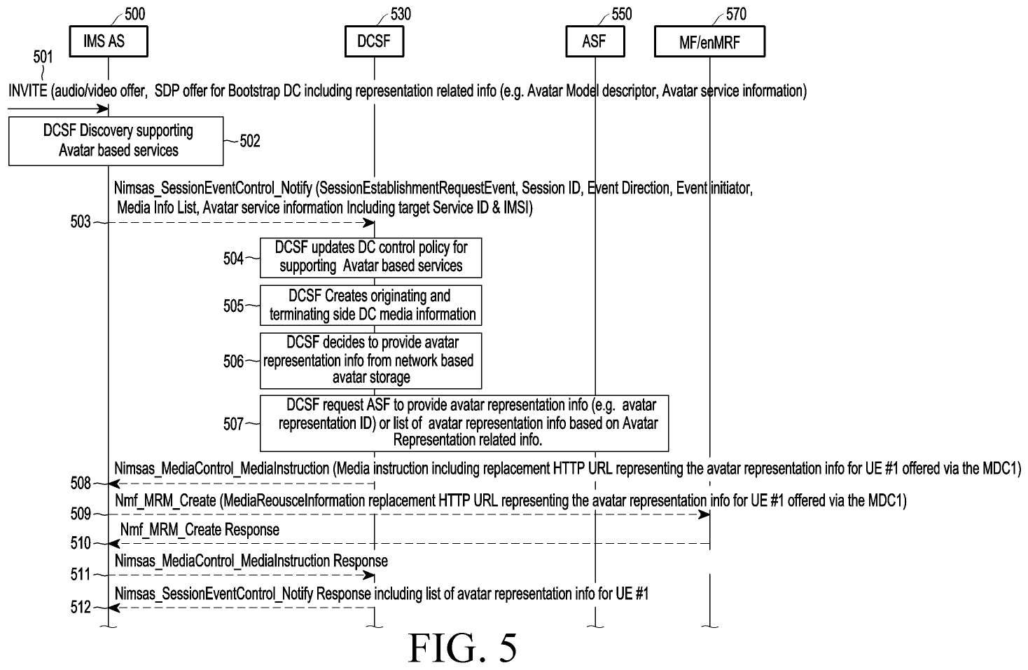

FIG. 5 is a flowchart illustrating a boot strap data channel setup signaling procedure on a data channel server (DCS) side according to a call session connection request including avatar representation-related information transferred by a UE according to an embodiment of the disclosure.

Referring to FIG. 5, a DCS may include an IMS application server (AS), a data channel signaling function (DCSF) entity, a media function (MF) entity, and a DC-AS entity related to an IMS-DC service in a local network. Hereinafter, for convenience of description, it should be noted that “UE” and “terminal” may be interchangeably used.

In FIG. 5, the originating UE (UE #1) (not shown in FIG. 5) may request data channel application and avatar representation information from the network to use an avatar-based IMS-DC service through a bootstrap data channel setup signaling procedure. Further, when the application data channel connection type is P2P, an SIP INVITE message including avatar representation-related information and the data channel application requested by UE #1 may be transferred to the terminating UE (UE #2) (not shown in FIG. 5).

In an embodiment of the disclosure, the DCSF entity 530 may generate data channel application and avatar representation information-related replacement hypertext transfer protocol (HTTP) uniform resource locator (URL) information in the bootstrap DC session based on the data channel application and avatar representation information and know that it should be supported through the local MF and include the related HTTP proxy operation in the media resource instruction and transfer the same to the MF/enMRF entity 570. In an embodiment of the disclosure, the MF/enMRF entity 570 may include an MF entity and/or enhanced multimedia resource function (enMRF) entity.

In operation 501, the UE UE #1 may transmit, to the IMS AS 500, a session initiation protocol (SIP) INVITE message including a session description protocol (SDP) offer for an audio, video, and bootstrap data channel connection request. If the service connection-requested by the UE UE #1 is an avatar-based service, avatar representation-related information for receiving the avatar representation information of the UE UE #1 user supported in the avatar storage in the network may be included in the bootstrap data channel session connection request information. In an embodiment of the disclosure, to request avatar representation information of the UE UE #1 user supported in the avatar storage in the network, the UE UE #1 may include avatar service information including avatar ID and pose type (e.g., T-pose), avatar service provider (e.g., Samsung, or the like), codec (e.g., PCC or mesh) or such a media format descriptor, level of detail (LoD) information, such as number of geometry or such avatar representation-related configuration information, and additionally, service information requesting the corresponding avatar, IMSI or such user information, in the SIP INVITE message upon the bootstrap data channel connection procedure.

The IMS AS 500 receiving the SIP INVITE message including the SDP offer including the avatar service information may perform an operation for selecting a DCSF entity supporting the avatar storage function entity in operation 502. The IMS AS 500 may separately select a connection to the DCSF entity supporting the avatar storage function entity when the avatar representation-related information is included in the data channel service-related request information transferred from the UE UE #1. Whether the DSCF entity supports the avatar storage function entity may be determined based on a service requesting subscription or registered by transferring, to the IMS AS 500, together DCSF entity-supportable service-related information upon data channel-related information subscription operation. Further, the DCSF entity may register service information supportable by the DCSF entity upon registration to the network repository function (NRF), and the IMS AS 500 may perform a connection operation for use of a data channel service and selection of a DCSF entity supporting a necessary service based on information in the SIP INVITE message transferred by the UE UE #1. In FIG. 5, it is assumed that the selected DCSF entity is the DCSF entity 530.

In operation 503, the IMS AS 500 may transfer, to the DCSF entity 530, a session event control notification (SessionEventControl_Notify) message including SessionEstablishmentRequestEvent, session ID, calling ID, called ID, session case, event initiator, media InfoList, DC Stream ID or such information, and avatar representation-related configuration information and avatar-related service information, for application data channel connection request to the DCSF entity 530. In an embodiment of the disclosure, the session event control notification message may include avatar service information including the IMSI of the UE UE #1 and the target service ID.

In operation 504, the DCSF entity 530 receiving the session event control notification message may perform a data channel control policy update operation for supporting download of data channel application and avatar representation information.

In operation 505, the DCSF entity 530 may perform a media resource generation operation of the originating UE UE #1 and the terminating UE UE #2 for transferring and setting up related information for supporting data channel application download in the MF/enMRF entity 570, such as MDC1 endpoint allocation information for receiving, through MDC1 between the DCSF entity 530 and the MF/enMRF entity 570, the data channel application and mapping information (replacement URL for DC application) or conversion related to the data channel application for receiving, in the DCSF entity 530, data channel application information requested from the UE UE #1 based on appropriate data channel application information based on information for supporting the avatar-related service through the avatar storage and the information received from the IMS AS 500. In an embodiment of the disclosure, MDC1 may be a reference point for transport of data channel media between data channel media function (or MF or MRF) and the DCSF entity 530.

In operation 506, the measurement/evaluation may determine whether to provide avatar representation information through the ASF entity connected to the DCSF entity 530 based on the avatar representation-related information received from the IMS AS 500. In FIG. 5, it is assumed that the ASF entity connected to the DCSF entity 530 is an ASF entity 550.

In operation 507, the DCSF entity 530 may transfer, to the ASF entity 550, the avatar representation-related information and service-related information received from the IMS AS 500 in operation 503 and request whether the avatar storage function entity supports the avatar service and whether it supports UE UE #1 user-related avatar representation information, requested by the UE UE #1. The ASF entity 550 may determine whether to provide avatar representation information according to the request of the service user and the service based on the service-related information, such as service ID and called ID received from the DCSF entity 530. When the ASF entity 550 is able to provide avatar representation information desired by the service user in the avatar-related service requested by the service user according to the request of the service user, the avatar representation information or avatar representation information list of the service user (e.g., UE UE #1) providable from the ASF entity 550 may be transferred to the DCSF entity 530. The DCSF entity 530 receiving the avatar representation information or avatar representation information list according to the request of the service user in the ASF entity 550 may generate information for supporting download to the UE UE #1 or MF/enMRF entity 570 of the avatar representation information through avatar storage over the network. For example, the UE UE #1 may request the DCSF entity 530 to transfer to the UE UE #1 or the MF/enMRF entity 570 through the MF/enMRF entity 570 according to the application data channel connection type of the avatar representation information based on the avatar representation-related information (Avatar Representation ID). The MF/enMRF entity 570 receiving the request information may convert the avatar representation-related information (avatar representation ID) of the UE UE #1 or convert based on the mapping information (replacement URL for avatar representation information) and then transfer it to the DCSF entity 530. The DCSF entity 530 may perform a media resource generation operation for supporting transfer of avatar representation information on the originating UE UE #1 and the terminating UE UE #2 sides for transferring and setting up, in the MF/enMRF entity 570, MDC1 endpoint allocation information and mapping information (replacement URL for avatar representation information) or conversion of avatar representation-related information (avatar representation ID) of the UE UE #1 for supporting the same.

In operation 508, the DCSF entity 530 may transfer, to the IMS AS 500, media resource information for supporting download of data channel application and avatar representation information to be transferred to the MF/enMRF entity 570. The IMS AS 500 may perform, through the NRF entity, an operation for selecting an appropriate MF/enMRF entity based on media resource information received from the DCSF entity 530.

In operation 509, the IMS AS 500 receiving media resource information of the MF/enMRF entity 570 from the DCSF entity 530 may transfer the same to the MF/enMRF entity 570 to perform a media resource allocation operation for supporting download of data channel application and avatar representation information in the MF/enMRF entity 570.

In operation 510, the MF/enMRF entity 570 may transfer, to the IMS AS 500, a media resource management generation operation response message (Nmf_MRM_Create Response) including MDC1 endpoint resource allocation information of the MF/enMRF entity 570 and the result for the allocation request of media resources for supporting download of the data channel application and avatar representation information in the MF/enMRF entity 570 received from the IMS AS 500 in operation 509.

In operation 511, the IMS AS 500 may transfer, to the DCSF entity 530, a Nimsas_MediaControl_MediaInstruction response message including MDC 1 endpoint resource allocation information and the result for the allocation request of media resources in the MF/enMRF entity 570 received from the MF/enMRF entity 570.

In operation 512, the DCSF entity 530 may transfer, to the IMS AS 500, a response message to the session establishment request event including the avatar representation information or avatar representation list of the UE UE #1 and the data channel application-related information according to the request of the UE UE #1.

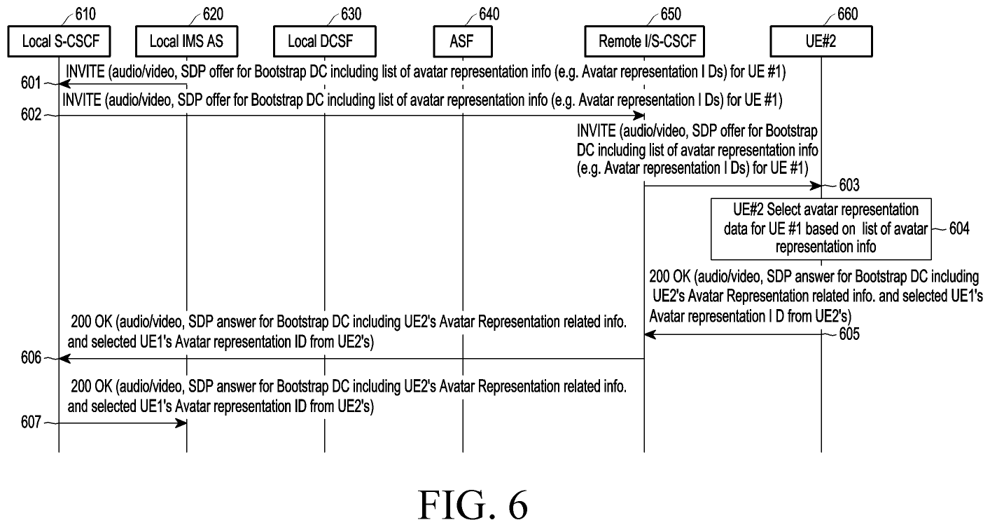

FIG. 6 is a flowchart illustrating a bootstrap data channel signaling procedure between a UE and a remote network and a local DCS related to an avatar service using avatar storage over a network according to an embodiment of the disclosure.

Referring to FIG. 6, the local DCS may include a DCSF entity, an MF entity, and a DC-AS entity related to the IMS-DC service in the originating network or local network. Hereinafter, for convenience of description, it should be noted that “UE” and “terminal” may be interchangeably used.

In operation 601, the IMS AS 620 on the local network side may transfer, to the remote network and UE UE #2 660 sides, SDP offer information updated based on, e.g., avatar representation information or avatar representation list of the UE UE #1 (not shown in FIG. 6) and data channel application-related information for supporting an avatar service using avatar storage from a DCSF entity 630 to transfer, to the S-SCSF entity 610 bypassing an ASF entity 640, an SIP INVITE message for requesting a bootstrap data channel session connection.

In operation 602, the S-CSCF entity 610 on the local network side may transfer, to the remote network and the UE UE #2 660, an SIP INVITE message including a modified SDP offer for requesting a bootstrap data channel session connection from the remote network and UE UE #2 660 received from the IMS AS 620.

In operation 603, the S-CSCF entity 650 over the remote network, receiving the SIP INVITE message including the changed or updated SDP offer from the local IMS AS 620 for bootstrap data channel session connection from the local network may transfer the SIP INVITE message to UE #2 660.

In operation 604, the remote UE (hereinafter UE #2) 660 may determine whether to accept the bootstrap data channel connection request based on the data channel application-related information in the SIP INVITE message received through the S-CSCF entity 650. Further, UE #2 660 may select the UE #1-related avatar representation information based on the avatar representation information or avatar representation list of UE #1. The avatar representation information may include avatar representation ID and model information of the avatar representation information, codec information, and version information.

In operation 605, UE #2 660 may determine whether to accept the connection request of bootstrap data channel sessions and transfer a response message (e.g., 200 OK) to the remote S-CSCF entity 650. In this case, avatar service-related avatar representation-related information, as well as information about the connection request of the bootstrap data channel sessions may be included in the response message. The avatar representation-related information may include avatar representation-related information of UE #2 660 for requesting avatar representation information of UE #2 660 from the avatar storage and avatar representation information of UE #1 selected considering, e.g., the capability of UE #2 660 by UE #2 660.

In operation 606, the remote S-CSCF entity 650 receiving the response message related to the bootstrap data channel connection request message from UE #2 660 may transfer the same to the local S-CSCF entity 610.

In operation 607, the local S-CSCF entity 610 receiving the response message related to the bootstrap data channel connection request message from the remote network and UE #2 660 may transfer the same to the local IMS AS 620 to request to transfer information for the bootstrap data channel connection to the DCSF entity 630.

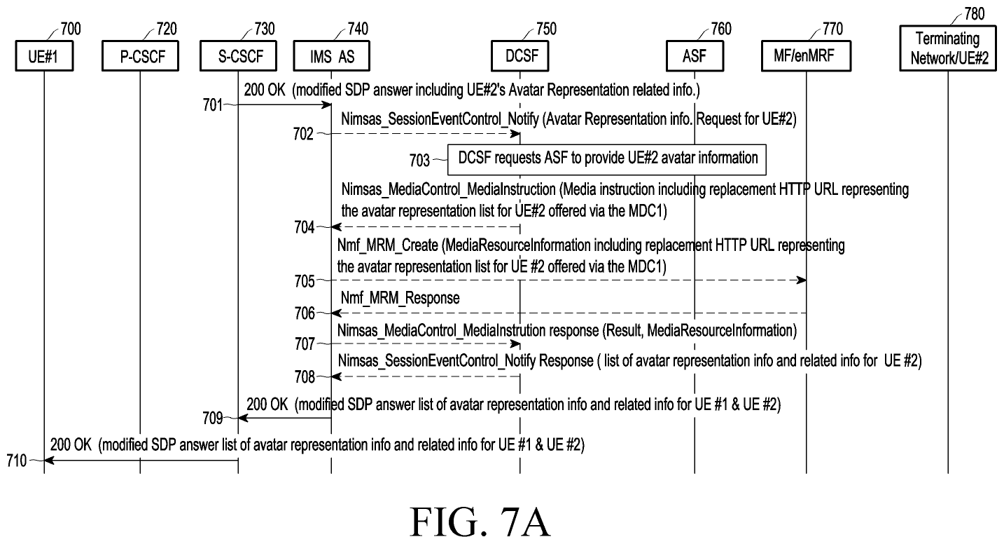

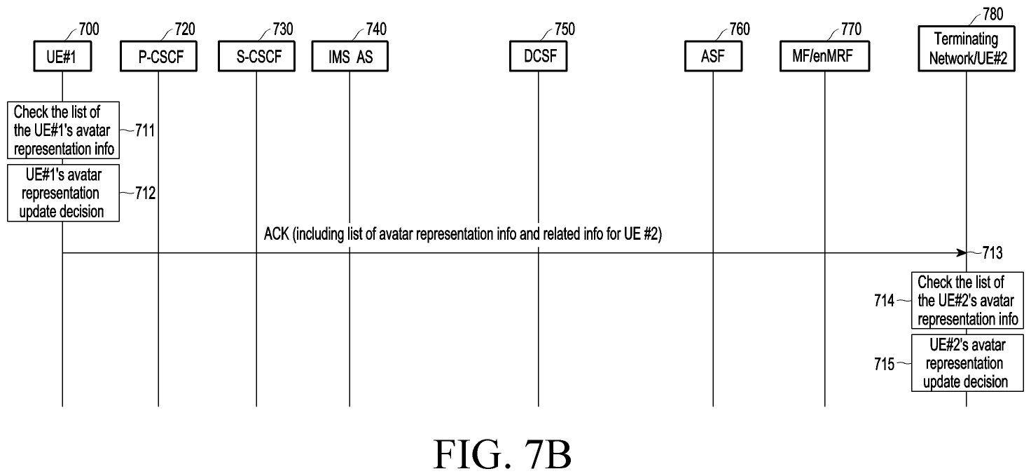

FIG. 7A is a flowchart illustrating a bootstrap data channel signaling procedure between a local DCS and a UE and a remote network related to an avatar service using avatar storage over a network according to an embodiment of the disclosure.

FIG. 7B is a flowchart illustrating a bootstrap data channel signaling procedure between a local DCS and a UE and a remote network related to an avatar service using avatar storage over a network according to an embodiment of the disclosure.

Referring to FIGS. 7A and 7B, in operation 701, an S-CSCF entity 730 located near a P-CSCF entity 720 may receive related information for bootstrap data channel connection of the remote network and the UE (e.g., UE #2) based on the response message transferred from the remote network and the UE (e.g., UE #2). In this case, the response message transferred from the remote network or the UE (e.g., UE #2) may be a 200 OK or 183 session progress. In an embodiment of the disclosure, it is assumed that the remote UE (UE #2)-related response information is transferred through 200 OK. When the 200 OK response message includes the bootstrap data channel-related response message (SDP answer), the S-CSCF entity 730 may transfer the same to an IMS AS 740.

In operation 702, the IMS AS 740 may transfer media change request event information for performing a UE #2-related media resource update based on the bootstrap data channel response message related to the remote network or the UE (e.g., UE #2) to a DCSF entity 750 through a session event control notification (SessionEventControl_Notify) including MediaChangeRequest Event, Session ID, Event Direction, Event initiator, Media Info List or such information. In this case, the session event control notification message transferred to the DCSF entity 750 may also include information, such as Service ID, Application Type, Avatar representation related information from UE #2.

In operation 703, the DCSF entity 750 may determine to process the avatar representation-related information transferred from UE #2 780 while simultaneously performing an update of the media stream-related media resource information transmitted to UE #2 780 in the MF/enMRF 770. In an embodiment of the disclosure, the MF/enMRF entity 770 may include an MF entity and/or an enMRF entity. The DCSF entity 750 may transfer UE #2 780-related avatar representation-related information to an ASF entity 760 and receive avatar representation information or avatar representation information list of UE #2 780 available in the avatar service. The DCSF entity 750 may perform an IMS DC policy update operation and media resource information generation related to avatar-related mapping information (replacement URL for UE #2 avatar representation information) of UE #2 780 in the MF/enMRF entity 770 based on the UE #2 780-related avatar representation information or representation information list received from the ASF entity 760.

In operation 704, the DCSF entity 750 may include updated media resource-related information including, e.g., avatar representation information-related mapping information (replacement URL for UE #2 avatar representation information) of UE #2 780 for supporting download and management of UE #2 780-related avatar representation information and download of avatar service-related data channel application between the MF/enMRF entity 770 and UE #2 780 in the data channel media resource information and transfer a media related instruction (MediaInstruction) for media resource control in the MF/enMRF entity 770 to the IMS AS 740.

In operation 705, the IMS AS 740 may transfer, to the MF/enMRF entity 770, a media resource management request (Nmf_MRM_Create Request) message including the avatar representation information-related mapping information (replacement URL for UE #2 avatar representation information) of the UE #2 780 and media resource-related information generated or updated in the MF, received from the DCSF entity 750.

In operation 706, the MF/enMRF entity 770 may transfer, to the IMS AS 740 through a media resource management request response (Nmf_MRM_Create Request Response) message, the media resource update result information for supporting download and management of the avatar representation information of UE #2 780 in the local MF based on the avatar representation information-related mapping information (replacement URL for UE #2 avatar representation information) of UE #2 780.

In operation 707, the IMS AS 740 may transfer the media resource update result and related information in the MF/enMRF entity 770 received from the MF/enMRF entity 770 to the DCSF entity 750.

In operation 708, the DCSF entity 750 may transfer, to the IMS AS 740 through a session event control notification response message, result information for the media change request event including the avatar representation information or avatar representation information list of UE #2 780 supported in the avatar storage function entity based on the avatar representation-related information and service information of UE #2 780 in the response message received from UE #2 780.

In operation 709, the IMS AS 740 may include, in the 200 OK message, the SDP answer updated or modified based on the avatar representation information or avatar representation information list related to each UE (UE #1 7000 and UE #2 780) using the service and the data channel application or data channel application list supporting the avatar service requested by UE #1 700.

In operation 710, the S-CSCF entity 730 receiving the 200 OK message including the updated or modified SDP answer may transfer the same to UE #1 700.

If the 200 OK message or 183 session progress message received by UE #1 700 includes the avatar representation information or avatar representation information list, it may perform an operation of managing the avatar representation information.

In operation 711, UE #1 700 may perform an operation (e.g., an avatar version check operation of UE #1 700 in avatar storage) for determining an additional operation (e.g., an operation of updating avatar representation information in avatar storage over network) for managing UE #1-related avatar representation information based on the received UE #1-related avatar representation information or avatar representation information list. In an embodiment of the disclosure, UE #1 700 may check whether the network storage provides the latest avatar representation information of UE #1 700 based on the avatar representation information and related information (version ID) of UE #1 700 supported in the avatar storage, received from the network.

In operation 712, when the network storage fails to provide the UE #1 700-related latest avatar representation information or UE #1 700 fails to provide a desired service type (e.g., high-quality avatar representation information), it may determine to request to update the avatar representation information of UE #1 700 in the avatar storage.

In operation 713, UE #1 700 may include the avatar representation information of UE #2 780 provided from the avatar storage and transfer an ACK message for notifying that successful service connection setup is completed to UE #2 780.

In operation 714, UE #2 780 may perform an operation (e.g., an avatar version check operation of UE #2 780 in avatar storage) for determining an additional operation (e.g., an operation of updating avatar representation information in avatar storage over network) for managing UE #2-related avatar representation information based on the received UE #2-related avatar representation information or avatar representation information list. In an embodiment of the disclosure, UE #2 780 may check whether the network storage provides the latest avatar representation information of UE #1 700 based on the avatar representation information and related information (version ID) of UE #2 780 supported in the avatar storage, received from the network.

In operation 715, when the network storage fails to provide the UE #2-related latest avatar representation information or UE #2 780 fails to provide a desired service type (e.g., high-quality avatar representation information), it may determine to request to update the avatar representation information of UE #2 780 in the avatar storage.

If failing to receive the avatar representation information related to UE #1 and UE #2 from the DCSF entity 750 through the 200 OK message and the ACK message from operation 709 through operation 713, each UE (UE #1 700 and UE #2 780) may transmit a message requesting to transfer the avatar representation information or avatar representation information list to the MF/enMRF entity 770 through the bootstrap data channel (Mb interface). The MF/enMRF entity 770 receiving the avatar representation information transfer request may convert the root URL based on the avatar representation information-related mapping information (replacement URL for and UE UE #1 and UE #2 avatar representation information) related to each UE, received in operations 507 and 703, and transfer the corresponding message to the DCSF entity 750. The DCSF entity 750 receiving the avatar representation information request message may transfer the avatar representation information or avatar representation information list to each UE (UE #1 700 and UE #2 780) through the MF/enMRF entity 770.

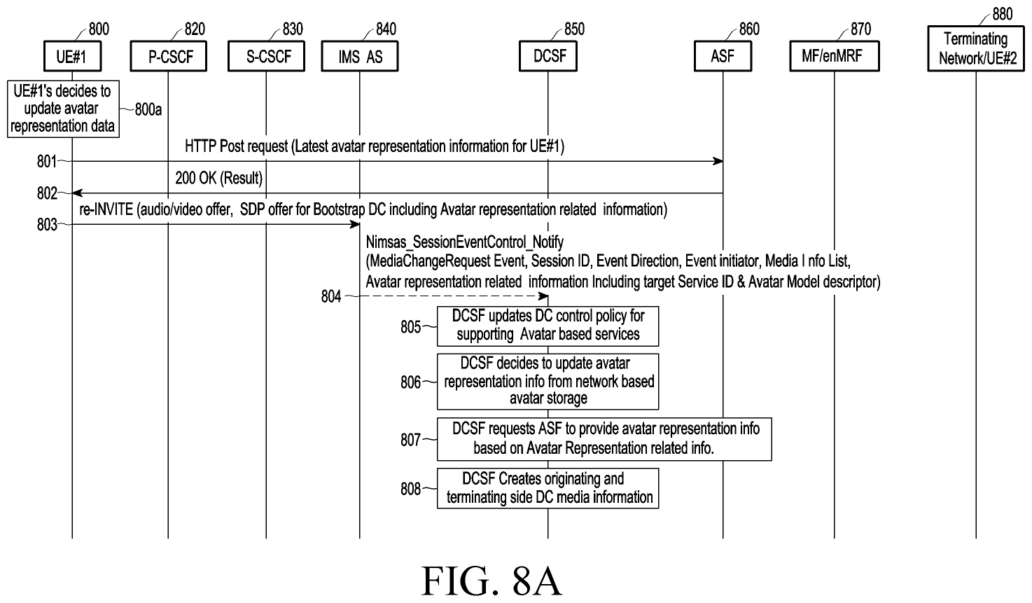

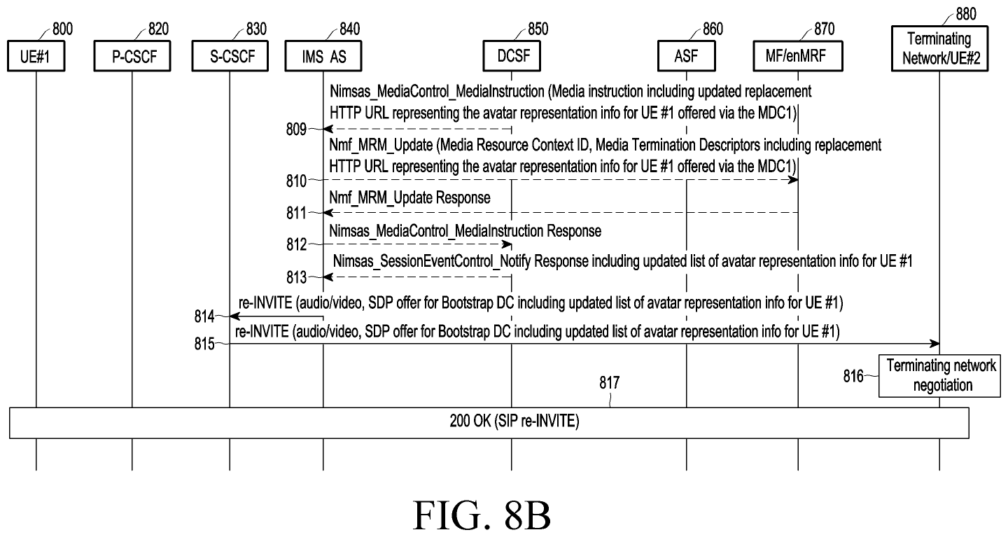

FIG. 8A is a flowchart illustrating a bootstrap data channel setup signaling procedure for updating service-related information after updating avatar representation information in avatar storage in a UE according to an embodiment of the disclosure.

FIG. 8B is a flowchart illustrating a bootstrap data channel setup signaling procedure for updating service-related information after updating avatar representation information in avatar storage in a UE according to an embodiment of the disclosure.

Referring to FIGS. 8A and 8B, in operation 800a, a UE UE #1 800 may determine to update the avatar representation information related to the user of the UE UE #1 800 in avatar storage based on the avatar representation information received from the network.

In operation 801, the UE UE #1 800 may transfer an HTTP post request message to the avatar storage to request to update the UE #1-related avatar representation information in the avatar storage to an ASF entity 860.

In operation 802, the UE UE #1 800 may receive result information about the UE #1-related avatar representation information update operation request requested through operation 801 from the avatar storage from the ASF entity 860.

In operation 803, the UE UE #1 800 may transfer a related service information update request for use of the updated avatar representation information in the avatar service to an IMS AS 840 through an SIP re-INVITE message after performing the avatar representation information update operation in the avatar storage. In this case, for the request of the updated avatar representation information, the UE

UE #1 800 may include avatar representation-related information including specific version information in the SDP offer.

In operation 804, the UE UE #1 800 may transfer, to a DCSF entity 850 through the session event control notification message (Nimsas_SessionEventControl_Notify), avatar representation-related information and media change request event information including the updated avatar representation information for request of the updated avatar representation information received from the UE UE #1 800.

In operation 805, the DCSF entity 850 may determine to update the avatar service-related data channel policy and perform an operation therefor.

In operation 806, the DCSF entity 850 may determine to update the avatar representation information based on the avatar representation-related information including, e.g., version information received from the UE UE #1 800.

In operation 807, the DCSF entity 850 may transfer the updated avatar representation-related information to the avatar storage function entity or avatar storage repository (avatar storage) and receive UE UE #1-related updated avatar representation information from the avatar storage.

In operation 808, the DCSF entity 850 may determine to update media resources in the MF/enMRF entity 870 based on the avatar representation information received from the avatar storage. In an embodiment of the disclosure, the MF/enMRF entity 870 may include an MF entity and/or an enMRF entity. The updated avatar representation information-related replacement URL information (updated replacement HTTP URL representing the avatar representation info for UE #1 offered via the MDC1) of UE #1 800 to be used in the avatar service may be included as the media resource in the MF/enMRF entity 870.

In operation 809, the DCSF entity 850 may transfer MF-related media indicator (media instruction) information including the updated avatar representation information-related replacement URL to the IMS AS 840 through the Nimsas_MediaControl_mediaInstruction message. The media indicator may include indication information for processing media in the IMS AS 840, such as TerminateAndOriginateMedia and UpdateMedia.

In operation 810, the IMS AS 840 may transfer the media indicator information including the updated avatar representation information-related replacement URL to the MF/enMRF entity 870 through the media resource management update (Nmf_MRM_Update) message.

In operation 811, the MF/enMRF entity 870 may transfer a media resource management update response message including the result information for the media resource management update request to the IMS AS 840.

In operation 812, the IMS AS 840 may transfer the indication that the media indicator information including the updated avatar representation information has been successfully updated in the MF/enMRF entity 870 to the DCSF entity 850.

In operation 813, the DCSF entity 850, after receiving the indication that the media indicator information in the MF/enMRF entity 870 has been successfully updated from the IMS AS 840, may transfer the updated avatar representation information list (updated list of avatar representation info for UE #1) of UE #1 800 requested from the UE UE #1 800 to the IMS AS 840 to indicate that the media change request event has been successfully performed.

In operation 814, the IMS AS 840 may transfer to an S-CSCF entity 830 located near a P-CSCF entity 820 using the SIP re-INVITE message including the updated avatar representation information list (updated list of avatar representation info for UE #1) of UE #1 800.

In operation 815, the S-CSCF entity 830 may transfer, to the terminating network and UE UE #2 880, the UE #1-related updated avatar representation information through the SIP re-INVITE message including the received updated avatar representation information list (updated list of avatar representation info for UE #1) of UE #1 800.

In operations 816 and 817, UE #2 880 may select the updated avatar representation information of UE #1 800 based on the updated avatar representation information list (updated list of avatar representation info for UE #1) of UE #1 800 and transfer the selected avatar representation information of UE #1 800 to the local DCSF entity 850 through the SIP re-INVITE response. The local DCSF entity 850 may determine whether to update media resources in the MF/enMRF entity 870 based on the response message of UE #2 880 and, when no separate update operation is necessary, transfer an SIP re-INVITE response including the updated avatar representation information list (updated list of avatar representation info for UE #1) of UE #1 800 to the IMS AS 840.

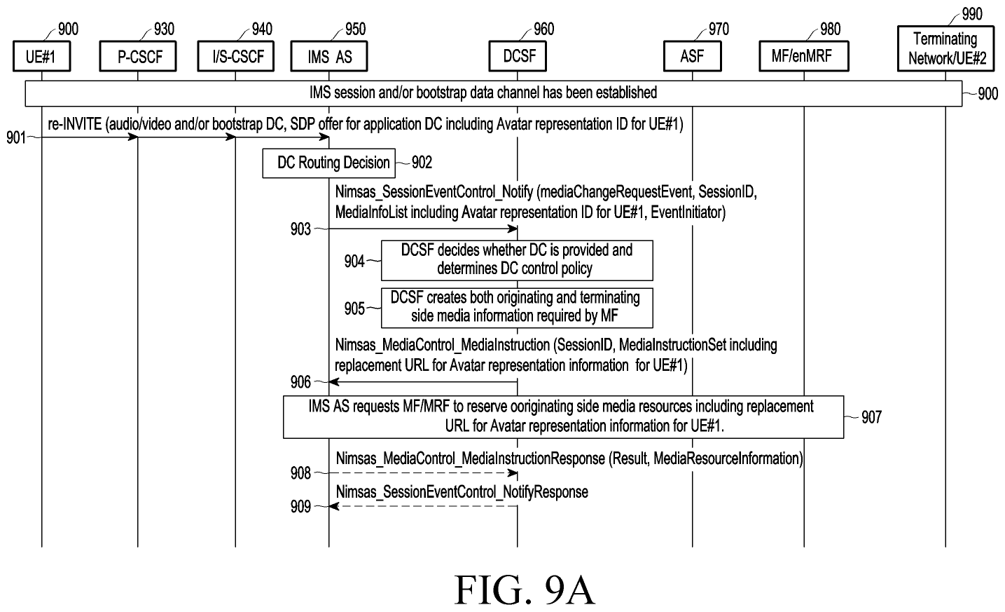

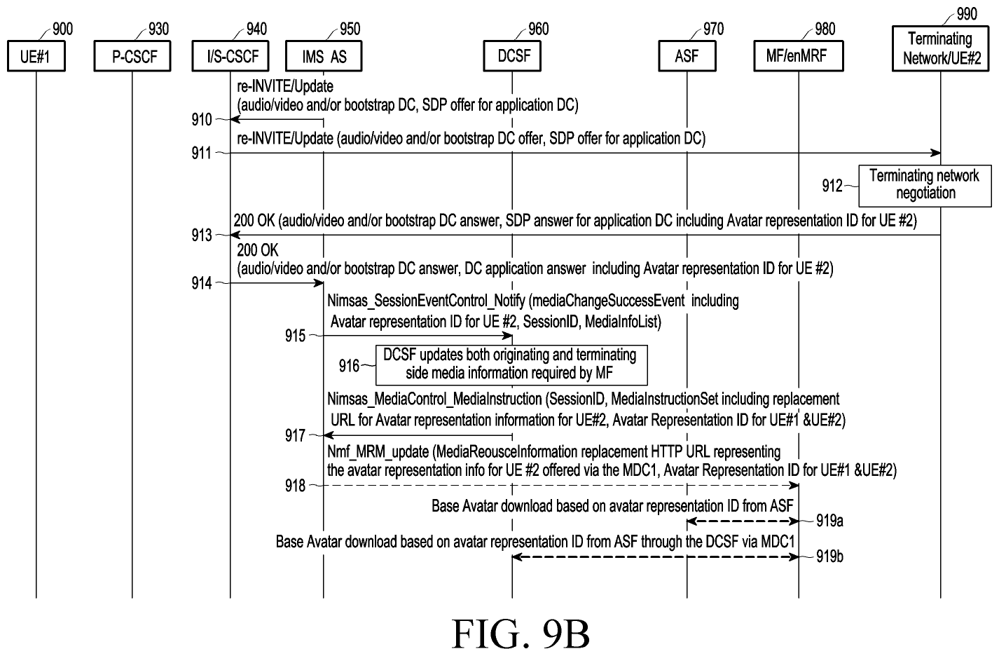

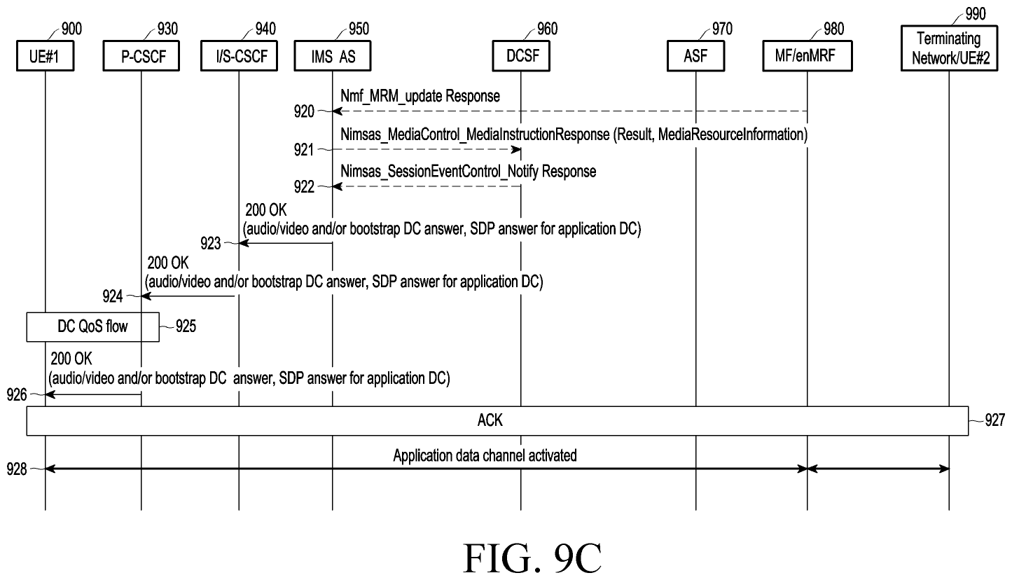

FIG. 9A is a flowchart illustrating an application data channel setup signaling procedure based on avatar representation information in avatar storage in a UE according to an embodiment of the disclosure.

FIG. 9B is a flowchart illustrating an application data channel setup signaling procedure based on avatar representation information in avatar storage in a UE according to an embodiment of the disclosure.

FIG. 9C is a flowchart illustrating an application data channel setup signaling procedure based on avatar representation information in avatar storage in a UE according to an embodiment of the disclosure.

Referring to FIGS. 9A to 9C, in operation 900, each UE may receive data channel application and related configuration information supporting the avatar service through a bootstrap data channel connection procedure. Additionally, to support the avatar service using network-based avatar storage, avatar representation information or avatar representation information list and related information of each UE user in the avatar storage may be received.

In operation 901, UE UE #1 900 may transfer an application data channel-related SDP offer to the IMS AS 950 through an SIP re-INVITE message to request session connection of a person to application to person (P2A2P) type data channel application. The application data channel-related SDP offer may include the avatar representation ID for UE #1. In FIG. 9A, it is assumed that an IMS session and/or bootstrap channel has been established before operation 901.

In operation 902, the IMS AS 950 may determine whether to perform application data channel session connection supporting local DCS-based avatar service or to perform application data channel session connection supporting remote DCS-based avatar service, based on the DC stream ID in the bootstrap data channel-related SDP offer or the bootstrap ID in the application data channel-related SDP offer.

In operation 903, the IMS AS 950 may transfer a session event control notification (SessionEventControl_Notify) message including avatar representation information, such as MediaChangeRequest Event, Session ID, Event Direction, Event initiator, Media Info List or such information and avatar representation ID or such avatar-related information for application data channel connection request to the DCSF entity 960.

In operation 904, the DCSF entity 960 receiving the session event control notification message may perform a data channel control policy update for application data channel connection supporting the avatar service and avatar representation information support through the avatar storage.

In operation 905, the DCSF entity 960 may generate media information on the originating and terminating sides in the MF/MRF entity 980 for application data channel connection for supporting the avatar service. In an embodiment of the disclosure, the MF/MRF entity 980 may include an MF entity and/or an MRF entity. For example, avatar service connection may be requested through network-based rendering when using the avatar service according to the service operator's selection or when each UE does not support the rendering function. As described above, to support network-based avatar rendering and generation, the UE may request P2A2P connection-type application data channel connection upon application data channel connection request. According to an embodiment of the disclosure, network-based avatar rendering may be supported using the avatar reference structure of FIG. 3. According to an embodiment of the disclosure, when the MF/MRF entity 980 supports network-based avatar rendering, the base avatar may be transferred from the avatar storage over the network to the MF/MRF entity 980, which may be used to generate an animation of the avatar based on the avatar animation data transferred from the UE UE #1 900. The DCSF entity 960 receiving the UE user's avatar representation information to be used for network-based avatar rendering from the UE through the application data channel connection request message may include the same in the media instruction.

In operation 906, the DCSF entity 960 may transfer the media instruction information including the UE user's avatar representation information (e.g., avatar representation ID) to be transferred to the MF/MRF entity 980 to the IMS AS 950.

In operation 907, the IMS AS 950 receiving the media instruction information including the UE user's avatar representation information (e.g., avatar representation ID) from the DCSF entity 960 may transfer the same to the MF/MRF entity 980 and perform a media resource allocation operation in the MF/MRF entity 980 for application data channel connection.

In operation 908, the IMS AS 950 may transfer it to the DCSF 960 through a Nimsas_MediaControl_MediaInstructionResponse message including the result for allocation request of media resources.

In operation 909, the DCSF entity 960 may transfer, to the IMS AS 950, the result for the media change request event including the media resource information in the local MF (e.g., MF/MRF entity 980) in relation to the IMS DC service media change request event requested by the IMS AS 950 in operation 903.

In operations 910 and 911, the IMS AS 950 may perform SDP offer update for application DC connection based on the media resource information in the local MF (e.g., the MF/MRF entity 980) received from the DCSF entity 960 and transfer the same to the remote network or UE #2 990.

In operation 912, the remote UE (hereinafter, UE #2) may determine whether to accept the connection request of the application data channel sessions based on the updated, modified SDP offer received from the local network and transfer the corresponding response message to the remote MF and local MF (e.g., the MF/MRF entity 980).

In operation 913, UE #2 990 may transfer a response message (e.g., 200 OK) including the avatar representation information (e.g., avatar representation ID for UE #2) related to UE #2 990, selected by UE #2 990 to the local network for use of avatar storage-based avatar service. Further, appropriate application data channel type information may be included in the response message (e.g., 200 OK) according to the capability of UE #2 990 and the remote network. For example, when a network-based avatar rendering service is requested due to a hardware issue with UE #2 990 or bad network status of UE #2 990, a response message (e.g., 200 OK) including the P2A2P or P2A (UE #2 990<-->MF/MRF entity 980) connection-type application data channel connection request may be transferred to the local network.

In operation 914, the S-CSCF entity 940 of the local network may transfer a response message including UE #2-related avatar representation information received from the remote network to the IMS AS 950.

In operation 915, the IMS AS 950 may transfer the response message including UE #2-related avatar representation information from the remote UE and network to the DCSF entity 960 to transfer information for media resource update in the MF/MRF entity 980 related to the media flow received from UE #2 990 to the DCSF entity 960 through the Nimsas_SessionEventControl_Notify message.

In operation 916, the DCSF entity 960 may perform determination of media information update on the terminating side in the MF/MRF entity 980 and related media instruction update based on the response information of UE #2 990, such as UE #2-related avatar representation information (e.g., avatar representation ID for UE #2) and application data channel connection type information. Further, determination of media information update on the originating and terminating sides and related media instruction update may be performed to perform the base avatar download operation in the MF/MRF entity 980 based on the avatar representation information (e.g., avatar representation ID for UE #1 & UE #2) received from each UE (UE #1 900 & UE #2 990) to perform the avatar animation rendering function in the MF/MRF entity 980 in the P2A2P connection type application.

In operation 917, the DCSF entity 960 may transfer a Nimsas_MediaControl_MediaInstruction message including the avatar representation information (e.g., avatar representation ID for UE #1 & UE #2) of UE #1 900 and UE #2 990 to the IMS AS 950 for downloading or preloading the base avatar in the MF/MRF entity 980 when using the network rendering-based avatar service and terminating-side media instruction information updated based on the information of UE #2 990.

In operation 918, the IMS AS 950 may transfer the updated MediaInstruction information including the replacement URL for the avatar representation list for UE #2 offered via the MDC1 information to the MF/MRF entity 980 through the Nmf_MRM_Update message to perform terminating-side media resource update in the MF/MRF entity 980. Further, the IMS AS 950 may transfer a terminating-side media resource update request in the MF to the MF/MRF entity 980 through the Nmf_MRM_Update message based on the avatar representation information (representation ID for UE #2) and the originating-side media resource update request (base avatar download) in the MF based on the avatar representation information (representation ID for UE #1) of avatar UE #1, transferring the base avatar download operation request in the MF/MRF entity 980.

In operation 919a, the MF/MRF entity 980 may perform a download operation of the avatar representation data (base avatar) from the MF/MRF entity 980 directly to the ASF entity 970 according to the network operator's settings and the position of the ASF.

In operation 919b, the MF/MRF entity 980 may perform conversion into the replacement URL for requesting the DCSF to download the avatar representation data based on the replacement URL information (replacement URL for the avatar representation IDs) mapped with each piece of avatar representation information (e.g., avatar representation ID) in the MF/MRF entity 980 according to the position of the ASF entity 970 and the network operator's settings. Thereafter, the MF/MRF entity 980 may request the DCSF entity 960 to transfer the avatar representation data (base avatar) related to the replacement URL information based on the replacement URL information. The DCSF entity 960 may transfer the replacement URL information to the ASF entity 970 to receive the avatar representation data requested by the MF/MRF entity 980 from the ASF entity 970 and transfer the same to the MF/MRF entity 980 through the MDC1 interface.

In operation 920, the MF/MRF entity 980 may transfer an Nmf_MRM_update Response message including the terminating-side media resource update result to the IMS AS 950 based on the updated Mediainstruction information based on the response message of UE #2 990 and download of avatar representation data.

In operation 921, the IMS AS 950 may transfer the MF-related media resource update result to the DCSF entity 960 through the Nimsas_MediaControl_MediaInstructionResponse message.

In operation 922, the DCSF entity 960 may receive the indication that download of the base avatar in the MF/MRF entity 980 has been successfully performed to support network rendering and the result for the terminating-side media resource update request based on the response message of UE #2 990 and then transfer the indication that the session-related operation has been successfully completed to the IMS AS 950.

In operations 923 and 924, the IMS AS 950 may transfer the indication that the application data channel connection setup has been successfully performed to the P-CSCF entity 930 through the S-CSCF entity 940 through a 200 OK message.

In operations 925 and 926, the P-CSCF entity 930 may perform a QoS allocation operation based on information in the 200 OK message indicating that the application data channel connection setup has been successfully performed and may finally transfer the indication that the application data channel connection has been successfully completed to UE #1 900 through the 200 OK message.

In operation 927, UE #1 900 may transfer the indication that the application data channel connection has been successfully completed to UE #2 990 by transferring the indication that the 200 OK message has been finally received through the ACK message.

In operation 928, each UE (e.g., UE #1 900 and UE #2 990) may complete the application data channel connection operation through the MF/MRF entity 980. In the case of an avatar service using network rendering, each UE (e.g., UE #1 900 and UE #2 990) may transfer the user's avatar animation data generated from each UE (e.g.,

UE #1 900 and UE #2 990) to the MF/MRF entity 980, and the MF receiving it may generate each user's avatar animation data based on the base avatar received from the ASF entity 970 in operation 919a and operation 919b. In this case, the avatar animation data generated in the MF/MRF entity 980 may be converted into, e.g., legacy media (e.g., video) and transferred according to a request of each UE (e.g., UE #1 900 and UE #2 990).

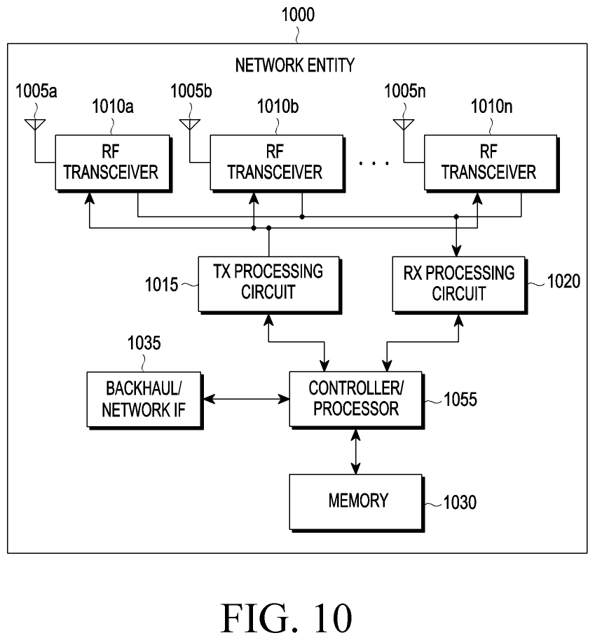

FIG. 10 is a view schematically illustrating a structure of a network entity 1000 according to an embodiment of the disclosure.

Referring to FIG. 10, the embodiment of the network entity is for illustrative purposes only, and FIG. 10 does not limit the scope of the disclosure to any specific implementation of the network entity. In an embodiment of the disclosure, the network entity may be a network entity that may be included in a communication system, such as an IMS AS, a DCSF entity, an ASF entity, an MF entity, an enMRF entity, a P-CSCF entity, an S-CSCF entity, or the like.

Referring to FIG. 10, the network entity includes a plurality of antennas 1005a to 1005n, a plurality of radio frequency (RF) transceivers 1010a to 1010n, a transmit (TX) processing circuit 1015, and a receive (RX) processing circuit 1020. The network entity further includes a controller/processor 1025, memory 1030, a controller/processor 1055, and a backhaul or network interface 1035.

The RF transceivers 1010a to 1010n receive input RF signals, such as signals transmitted from UEs in the network, through the antennas 1005a to 1005n. The RF transceivers 1010a to 1010n down-convert the input RF signals, generating intermediate frequency (IF) or baseband signals. The IF or baseband signals are transmitted to the RX processing circuit 1020, and the RX processing circuit 1020 filters, decodes, and/or digitizes the baseband or IF signals, generating processed baseband signals. The RX processing circuit 1020 sends the processed baseband signals to the controller/processor 1025 for further processing.

The TX processing circuit 1015 receives analog or digital data, such as speech data, web data, emails, or interactive video game data, from the controller/processor 1025. The TX processing circuit 1015 encodes, multiplexes, and/or digitizes the output baseband data, generating processed baseband or IF signals. The RF transceivers 1010a to 1010n receive the processed baseband or IF signals output from the TX processing circuit 1015 and up-convert the baseband or IF signals into RF signals which are to be transmitted through the antennas 1005a to 1005n.

The controller/processor 1025 may include one or more processors or other processing devices that control the overall operation of the network entity. In one example, the controller/processor 1025 may control reception of forward channel signals and transmission of reverse channel signals by the RF transceivers 1010a to 1010n, the processing circuit 1020, and the TX processing circuit 1015 according to known principles. The controller/processor 1025 may support additional functions, such as more advanced wireless communication functions.

In various embodiments of the disclosure, the controller/processor 1025 performs the overall operation related to the operations described in FIGS. 5 through 9C.

Further, the controller/processor 1025 may support beamforming or directional routing operations in which signals output from the plurality of antennas 1005a to 1005n are differently weighted to efficiently steer the signals output in a desired direction. Any of other various functions may be supported by the controller/processor 1025 in the network entity.

The controller/processor 1025 may also execute programs and other processes, e.g., operating system (OS), resident in the memory 1030. The controller/processor 1025 may move data as required by a running process to the memory 1030 or the outside of the memory 1030.

The controller/processor 1025 is connected with the backhaul or network interface 1035. The backhaul or network interface 1035 allows the network entity to communicate with other devices or systems over a backhaul connection or over a network. The interface 1035 may support communications over any appropriate wired or wireless connection(s). For example, when the network entity is implemented as a part of a cellular communication system (such as a cellular communication system supporting 5G, LTE, or LTE-A), the interface 1035 allows the network entity to communicate with other network entities via a wired or wireless backhaul connection. When the network entity is implemented as an access point, the interface 1035 allows the network entity to communicate with a larger network (e.g., the Internet) via a wired or wireless local area network or a wired or wireless connection. The interface 1035 includes an appropriate structure to support communications through a wired or wireless connection, such as Ethernet or RF transceiver.

The memory 1030 is connected to the controller/processor 1025. A portion of the memory 1030 may include random access memory (RAM), and another portion of the memory 1030 may include flash memory or read-only memory (ROM).

Although FIG. 10 illustrates an example of a network entity, various changes may be made thereto. As an example, the network entity may include any number of such components as illustrated in FIG. 10. As a specific example, an access point may include a plurality of interfaces 1035, and the controller/processor 1025 may support routing functions to route data between different network addresses. As another specific example, although it is illustrated that a single instance of the TX processing circuit 1015 and a single instance of the RX processing circuit 1020 are included, the network entity may include a plurality of instances of each (like one for each RF transceiver). Various components of FIG. 10 may be combined together, or each component may be further divided or some components may be omitted or, as necessary, more components may be added.

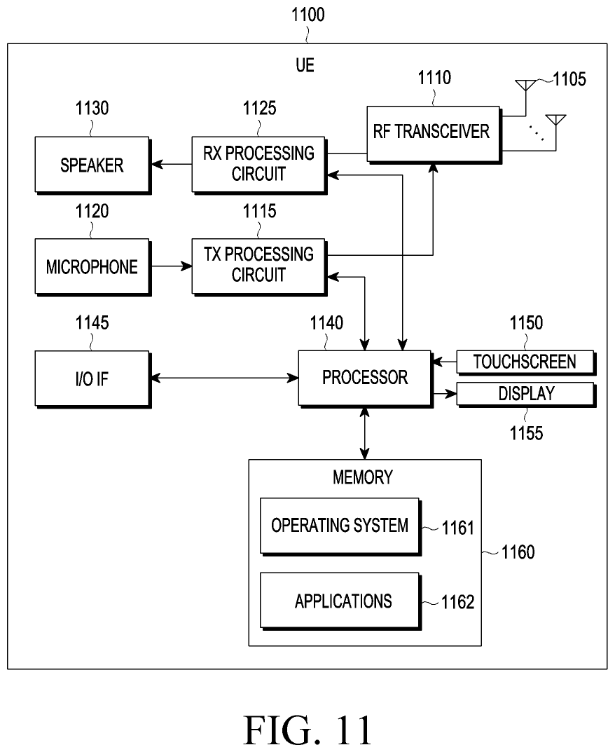

A structure of a UE according to an embodiment is described below with reference to FIG. 11.

FIG. 11 is a view schematically illustrating a structure of a UE 1100 according to an embodiment of the disclosure.

The embodiment of the UE illustrated in FIG. 11 is for illustrative purposes only, and the scope of the disclosure is not limited thereto.

Referring to FIG. 11, the UE may include an antenna 1105, a radio frequency (RF) transceiver 1110, a transmit (TX) processing circuit 1115, a microphone 1120, and a receive (RX) processing circuit 1125. The UE further includes a speaker 1130, a processor 1140, an input/output (I/O) interface (IF) 1145, a touch screen 1150, a display 1155, and memory 1160. The memory 1160 includes an operating system (OS) 1161 and one or more applications 1162.

The RF transceiver 1110 receives an input RF signal transmitted from a network entity in a network, via the antenna 1105. The RF transceiver 1110 down-converts the input RF signal, generating an intermediate frequency (IF) or baseband signal. The IF or baseband signal is transmitted to the RX processing circuit 1125, and the RX processing circuit 1125 filters, decodes, and/or digitizes the baseband or IF signal, generating a processed baseband signal. The RX processing circuit 1125 sends the processed baseband signal to the speaker 1130 (e.g., for speech data) or the processor 1140 (e.g., for web browsing data) for further processing.

The TX processing circuit 1115 receives analog or digital speech data from the microphone 1120 or other output baseband data (e.g., web data, emails, or interactive video game data) from the processor 1140. The TX processing circuit 1115 encodes, multiplexes, and/or digitizes the output baseband data, generating a processed baseband or IF signal. The RF transceiver 1110 receives the processed baseband or IF signal output from the TX processing circuit 1115 and up-converts the baseband or IF signal into an RF signal which is to be transmitted through the antenna 1105.

The processor 1140 may include one or more processors or other processing devices, and may execute the OS 1161 stored in the memory 1160 to control the overall operation of the UE. As an example, the processor 1140 may control reception of downlink channel signals and transmission of uplink channel signals by the RF transceiver 1110, the RX processing circuit 1125, and the TX processing circuit 1115 according to known principles. In an embodiment of the disclosure, the processor 1140 includes at least one microprocessor or microcontroller.

In an embodiment of the disclosure, the processor 1140 performs the overall operation (e.g., congestion information providing operation) related to the operations described in FIGS. 5, 6, 7A, 7B, 8A, 8B, 9A, 9B, and 9C.

The processor 1140 may execute other processes and programs embedded in the memory 1160, such as processes related to the L4S service. The processor 1140 may move data into or out of the memory 1160 as required by a running process. In an embodiment of the disclosure, the processor 1140 is configured to execute the applications 1162 based on the OS 1161 or in response to signals received from network entities or the operator. The processor 1140 is coupled to the input/output (I/O) interface 1145, and the I/O interface 1145 provides the UE with connectibility to other devices, e.g., laptop computers and handheld computers. The I/O interface 1145 is a communication path between these accessories and the processor 1140.

The processor 1140 is also connected to the touch screen 1150 and the display unit 1155. The operator of the UE may input data into the UE using the touch screen 1150. The display 1155 may be a liquid crystal display, a light emitting diode display, or other displays capable of rendering text and/or at least limited graphics, such as from websites.

The memory 1160 is connected to the processor 1140. A portion of the memory 1160 may include random access memory (RAM), and the remainder of the memory 1160 may include flash memory or read-only memory (ROM).

Although FIG. 11 illustrates an example UE, various changes may be made thereto. For example, various components of FIG. 11 may be combined together, each component may be further divided, or some components may be omitted, or other components may be added as necessary. As an example, the processor 1140 may be divided into multiple processors, such as one or more central processing units (CPUs) and one or more graphics processing units (GPUs). Although the UE is configured like a mobile phone or a smart phone in FIG. 11, the UE may be configured to operate as a different type of mobile or stationary device.

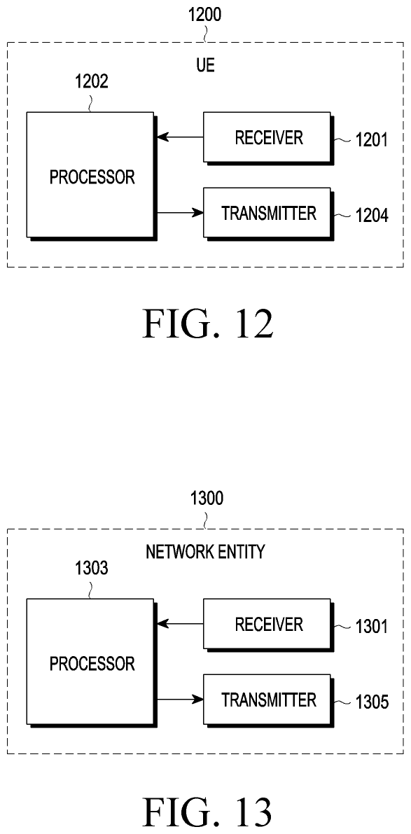

Another example of a structure of a UE according to an embodiment is described below with reference to FIG. 12.

FIG. 12 is a block diagram schematically illustrating a structure of a UE 1200 according to an embodiment of the disclosure.

Referring to FIG. 12, the UE may include a receiver 1201, a transmitter 1204, and a processing unit (or at least one processor) 1202. The receiver 1201 and the transmitter 1204 may collectively be referred to as a transmission/reception unit (or transceiver) in an embodiment of the disclosure. The transceiver may transmit/receive signals to/from the network entity. The signals may include control information and data. To that end, the transceiver may include an RF transmitter for frequency-up converting and amplifying transmitted signals and an RF receiver for low-noise amplifying and frequency-down converting received signals. The transceiver may receive signals via a radio channel, output the signals to the processor 1202, and transmit signals output from the processor 1202 via a radio channel. The processor 1202 may control a series of processes for the UE to operate according to the above-described embodiments.

Another example of a structure of a network entity according to an embodiment of the disclosure is described below with reference to FIG. 13.

FIG. 13 is a block diagram schematically illustrating a structure of a network entity 1300 according to an embodiment of the disclosure. A network entity (or network device (e.g., RAN node, AF entity, UDM entity, PCF entity, NRF entity, NEF entity, NSSF entity, AUSF entity, AMF entity, SMF entity, UPF entity, AP entity, AS, or base station)) may be any one of various entities included in a communication system (e.g., a mobile communication network).

Referring to FIG. 13, the network entity may include a receiver 1301, a transmitter 1305, and a processing unit (or at least one processor) 1303. The receiver 1301 and the transmitter 1305 may collectively be referred to as a transmission/reception unit (or transceiver) in an embodiment of the disclosure. The transceiver may transmit/receive signals to/from the UE. The signals may include control information and data. To that end, the transceiver may include an RF transmitter for frequency-up converting and amplifying transmitted signals and an RF receiver for low-noise amplifying and frequency-down converting received signals. The transceiver may receive signals via a radio channel, output the signals to the processor 1303, and transmit signals output from the processor 1303 via a radio channel. The processor 1303 may control a series of processes for the network entity to operate according to the above-described embodiments of the disclosure.

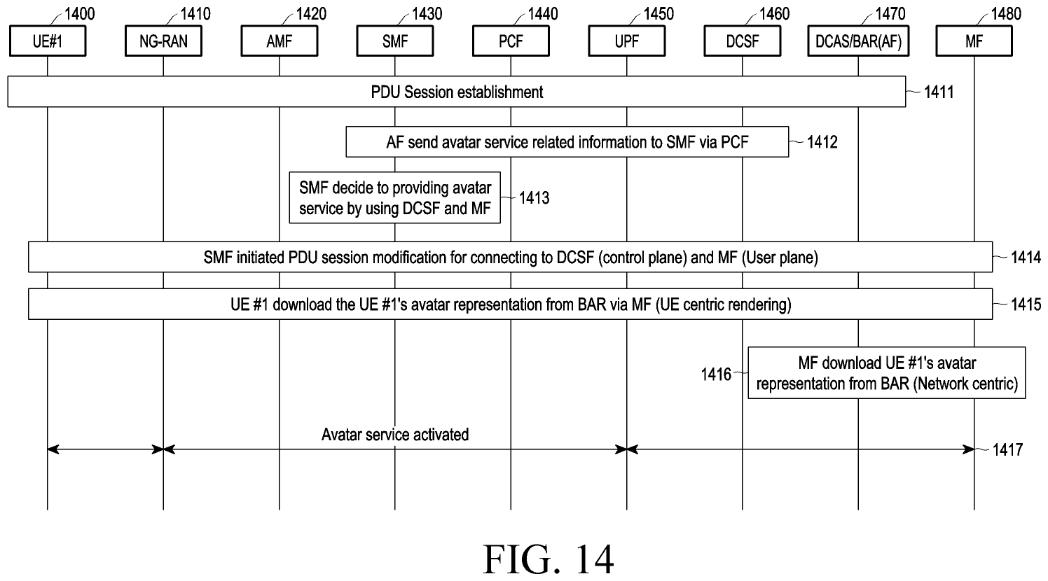

FIG. 14 is a flowchart illustrating the avatar service process in a terminal according to an embodiment of the disclosure.

Referring to FIG. 14, the wireless communication system may include at least one of UE #1 1400, NG-RAN 1410, AMF 1420, SMF 1430, PCF 1440, UPF 1450, DCSF 1460, DCAS/BAR (AF) 1470, and MF 1480. The wireless communication system can support 5G communication systems or 6G communication systems. It may also be supported by the system depicted in FIG. 14.

DCAS/BAR (AF) 1470 can perform at least one function among DC AS (data channel application server), BAR (base avatar repository), and AF.

In operation 1411, at least one among UE #1 1400, NG-RAN 1410, AMF 1420, SMF 1430, PCF 1440, UPF 1450, DCSF 1460, DCAS/BAR (AF) 1470, and MF 1480 may perform a PDU session establishment procedure.

In operation 1412, AF 1470 may transmit information related to the avatar service to SMF 1430. AF 1470 may transmit such information to SMF 1430 via PCF 1440.

In operation 1413, SMF 1430 may decide to provide the avatar service using DCSF 1460 and MF 1480.

In operation 1414, SMF 1430 may initiate a PDU session modification procedure to connect with DCSF 1460 and MF 1480. DCSF 1460 may include a control plane, and MF 1480 may include a user plane.

In operation 1415, UE #1 1400 may download the avatar representation of UE #1 from BAR 1470. UE #1 1400 may download the avatar representation via MF 1480. The procedure of UE #1 1400 downloading its avatar representation from BAR 1470 may indicate a UE-centric rendering.

In operation 1416, MF 1480 may download the avatar representation of UE #1 from BAR 1470. The procedure of MF 1480 downloading the avatar representation from BAR 1470 may indicate a network-centric procedure.

In operation 1417, MF 1480 may transmit the avatar representation of UE #1 to UPF 1450. MF 1480 and UPF 1450 may enable avatar services through the avatar representation of UE #1. NG-RAN 1410 and UPF 1450 may enable avatar services through the avatar representation. NG-RAN 1410 and UE #1 1400 may enable avatar services through the avatar representation of UE #1.

NG-RAN may include at least one of P-CSCF or I/S-CSCF. SMF may include IMS AS or perform functions similar to IMS AS. UPF may include MF or perform functions similar to MF.

UE may access ASF via MF to download information.

UE #1 may be referred to as a first terminal or first UE. UE #2 may be referred to as a second terminal or second UE. At least one of the first UE, second UE, or MF may negotiate to share an avatar ID. In other words, at least one among the first UE, second UE, or MF may share the avatar ID of the first UE or second UE.

The first UE or second UE may identify an avatar ID and/or terminal ID. They may grant access rights. When the first UE or second UE shares an avatar ID, they may perform a security check to authorize the use of the avatar ID.

Entity performing the data channel signaling function may include at least one of DCSF or entities supporting avatar-based services. Entity performing avatar storage functions may include at least one of avatar storage function (ASF), data channel application server (DC AS), data channel application repository (DC AR), or base avatar repository (BAR).

According to an embodiment of the disclosure, a method performed by an entity that performs data channel signaling functions in a communication system, may include transmitting a first message, which includes information related to an avatar of a first UE and information related to an application data channel connection request, to an entity that performs an avatar storage function receiving a message, from the entity performing the avatar storage function, which includes information related to a response to the application data channel connection request, requesting a list of avatar representation information from the entity performing the avatar storage function, and receiving the list of avatar representation information from the entity performing the avatar storage function.

According to an embodiment of the disclosure, wherein the entity performing the avatar storage function may include at least one of an avatar storage function (ASF), a data channel application server (DC AS), a data channel application repository (DC AR), or a base avatar repository (BAR).

According to an embodiment of the disclosure, the method may further include receiving the first message from the IP multimedia subsystem application server (IMS AS).

According to an embodiment of the disclosure, wherein the entity wherein the information related to the avatar of the first UE may include at least one of information related to the avatar-based service or information related to the avatar representation information.

According to an embodiment of the disclosure, the method may further include transmitting the list of avatar representation information to the first UE through a media function (MF).

According to an embodiment of the disclosure, wherein the entity wherein the entity performing the data channel signaling function may include at least one of a data channel signaling function (DSCF) or an entity that supports avatar-based services.

According to an embodiment of the disclosure, a method performed by a first UE in a communication system, may include transmitting a first message to an IP multimedia subsystem application server (IMS AS), the first message including information related to an avatar and information related to an application data channel connection request, and receiving avatar representation information through a media function (MF) from the IMS AS, wherein the avatar representation information includes a list of avatar representation information.

According to an embodiment of the disclosure, wherein the entity wherein the avatar representation information may include avatar representation information negotiated by the first UE and the second UE.

According to an embodiment of the disclosure, an entity that performs data channel signaling functions in a communication system, may include a transceiver, and at least one processor. The at least one processor may be configured to transmit a first message, which includes information related to an avatar of a first UE and information related to an application data channel connection request, to an entity that performs an avatar storage function, receive a message, from the entity performing the avatar storage function, which includes information related to a response to the application data channel connection request, request a list of avatar representation information from the entity performing the avatar storage function, and receive the list of avatar representation information from the entity performing the avatar storage function.

According to an embodiment of the disclosure, wherein the entity performing the avatar storage function may include at least one of an avatar storage function (ASF), a data channel application server (DC AS), a data channel application repository (DC AR), or a base avatar repository (BAR).

According to an embodiment of the disclosure, the at least one processor may be further configured to receive the first message from the IP multimedia subsystem application server (IMS AS).

According to an embodiment of the disclosure, wherein the information related to the avatar of the first UE may include at least one of information related to the avatar-based service or information related to the avatar representation information.

According to an embodiment of the disclosure, wherein the at least one processor may be further configured to transmit the list of avatar representation information to the first UE through a media function (MF).

According to an embodiment of the disclosure, wherein the entity performing the data channel signaling function may include at least one of a data channel signaling function (DSCF) or an entity that supports avatar-based services.

According to an embodiment of the disclosure, a first UE in a communication system, the UE may include a transceiver, and at least one processor. The at least one processor may be configured to transmit a first message to an IP multimedia subsystem application server (IMS AS), the first message including information related to an avatar and information related to an application data channel connection request, and receive avatar representation information through a media function (MF) from the IMS AS, wherein the avatar representation information includes a list of avatar representation information.

According to an embodiment of the disclosure, wherein the avatar representation information may include avatar representation information negotiated by the first UE and the second UE.

The methods according to the embodiments descried in the specification or claims of the disclosure may be implemented in hardware, software, or a combination of hardware and software.

When implemented in software, there may be provided a computer readable storage medium storing one or more programs (software modules). One or more programs stored in the computer readable storage medium are configured to be executed by one or more processors in an electronic device. One or more programs include instructions that enable the electronic device to execute methods according to the embodiments described in the specification or claims of the disclosure.

The programs (software modules or software) may be stored in random access memories, non-volatile memories including flash memories, read-only memories (ROMs), electrically erasable programmable read-only memories (EEPROMs), magnetic disc storage devices, compact-disc ROMs, digital versatile discs (DVDs), or other types of optical storage devices, or magnetic cassettes. Alternatively, the programs may be stored in memory constituted of a combination of all or some thereof. As each constituting memory, multiple ones may be included.

The programs may be stored in attachable storage devices that may be accessed via a communication network, such as the Internet, Intranet, local area network (LAN), wide area network (WLAN), or storage area network (SAN) or a communication network configured of a combination thereof. The storage device may connect to the device that performs embodiments of the disclosure via an external port. A separate storage device over the communication network may be connected to the device that performs embodiments of the disclosure.

In the above-described specific embodiments of the disclosure, the components included in the disclosure are represented in singular or plural forms depending on specific embodiments proposed. However, the singular or plural forms are selected to be adequate for contexts suggested for ease of description, and the disclosure is not limited to singular or plural components. As used herein, the singular forms “a,” “an,” and “the” are intended to include the plural forms as well, unless the context clearly indicates otherwise.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by an entity that performs data channel signaling functions in a communication system, the method comprising:
transmitting a first message, which includes information related to an avatar of a first user equipment (UE) and information related to an application data channel connection request, to an entity that performs an avatar storage function;
receiving a message, from the entity performing the avatar storage function, which includes information related to a response to the application data channel connection request;
requesting a list of avatar representation information from the entity performing the avatar storage function; and
receiving the list of avatar representation information from the entity performing the avatar storage function.

2. The method of claim 1, wherein the entity performing the avatar storage function includes at least one of an avatar storage function (ASF), a data channel application server (DC AS), a data channel application repository (DC AR), or a base avatar repository (BAR).

3. The method of claim 1, further comprises:
receiving the first message from an IP multimedia subsystem application server (IMS AS).

4. The method of claim 1, wherein the information related to the avatar of the first UE includes at least one of information related to an avatar-based service or information related to the avatar representation information.

5. The method of claim 1, further comprises:
transmitting the list of avatar representation information to the first UE through a media function (MF).

6. The method of claim 1, wherein the entity performing the data channel signaling function includes at least one of a data channel signaling function (DSCF) or an entity that supports avatar-based services.

7. A method performed by a first user equipment (UE) in a communication system, the method comprising:
transmitting a first message to an IP multimedia subsystem application server (IMS AS), the first message including information related to an avatar and information related to an application data channel connection request; and
receiving avatar representation information through a media function (MF) from the IMS AS,
wherein the avatar representation information includes a list of avatar representation information.

8. The method of claim 7, wherein the avatar representation information includes avatar representation information negotiated by the first UE and a second UE.

9. An entity that performs data channel signaling functions in a communication system, the entity comprising:
a transceiver; and
at least one processor,
wherein the at least one processor is configured to:
transmit a first message, which includes information related to an avatar of a first user equipment (UE) and information related to an application data channel connection request, to an entity that performs an avatar storage function,
receive a message, from the entity performing the avatar storage function, which includes information related to a response to the application data channel connection request,
request a list of avatar representation information from the entity performing the avatar storage function, and
receive the list of avatar representation information from the entity performing the avatar storage function.

10. The entity of claim 9, wherein the entity performing the avatar storage function includes at least one of an avatar storage function (ASF), a data channel application server (DC AS), a data channel application repository (DC AR), or a base avatar repository (BAR).

11. The entity of claim 9, wherein the at least one processor is further configured to receive the first message from an IP multimedia subsystem application server (IMS AS).

12. The entity of claim 9, wherein the information related to the avatar of the first UE includes at least one of information related to an avatar-based service or information related to the avatar representation information.

13. The entity of claim 9, wherein the at least one processor is further configured to transmit the list of avatar representation information to the first UE through a media function (MF).

14. The entity of claim 9, wherein the entity performing the data channel signaling function includes at least one of a data channel signaling function (DSCF) or an entity that supports avatar-based services.

15. A first user equipment (UE) in a communication system, the UE comprising:
a transceiver; and
at least one processor,
wherein the at least one processor is configured to:
transmit a first message to an IP multimedia subsystem application server (IMS AS), the first message including information related to an avatar and information related to an application data channel connection request, and
receive avatar representation information through a media function (MF) from the IMS AS, and
wherein the avatar representation information includes a list of avatar representation information.

16. The first UE of claim 15, wherein the avatar representation information includes avatar representation information negotiated by the first UE and a second UE.
